(19) United States
(12) Patent Application Publication
(10) Pub. No.: US 2024/0117944 A1
(43) Pub. Date: Apr. 11, 2024

(54) SYSTEM FOR PROVIDING INTEGRATED PIPELINE INTEGRITY DATA

(71) Applicant: FATHOM SOLUTIONS FOR COMMUNICATIONS AND INFORMATION TECHNOLOGY, Eastern Region (SA)

(72) Inventor: Mehdi Hassan PIRSIAVASH, Muscat (OM)

(73) Assignee: FATHOM SOLUTIONS FOR COMMUNICATIONS AND INFORMATION TECHNOLOGY, Eastern Region (SA)

(21) Appl. No.: 18/107,817

(22) Filed: Feb. 9, 2023

Related U.S. Application Data
(63) Continuation-in-part of application No. 17/942,712, filed on Sep. 12, 2022.
(60) Provisional application No. 62/989,065, filed on Mar. 13, 2020.

(51) Int. Cl. F17D 5/06

(52) U.S. Cl. CPC F17D 5/06

(57) ABSTRACT

A method and non-transitory computer readable storage medium for providing an integrated pipeline data user interface using one standard platform. The method includes, collecting, by a processor, In-Line Inspection (ILI) pipeline inspection reports having different formats; converting, by the processor, the different In-Line Inspection (ILI) pipeline inspection reports into one standard platform; and generating, by the processor, an integrated pipeline data user interface using the one standard platform.

### CROSS-REFERENCE TO RELATED APPLICATIONS

This application is a continuation-in-part of U.S. patent application Ser. No. 17/942,712 filed Sep. 12, 2022, which claims priority from, PCT/IB2021/053901, filed on May 7, 2021, which claims priority from U.S. Provisional Application No. 62/989,065 filed on Mar. 13, 2020 in the U.S. Patent & Trademark Office, the disclosures of which are incorporated herein by reference in their entirety.

### TECHNICAL FIELD

Aspects of one or more non-limiting embodiments of the disclosure generally relate to analyzing the integrity of oil and gas transmission pipes and to methods, apparatuses, and systems for providing an interface for comprehensively collecting a wide variety of pipeline integrity related data sets, and inspection and survey reports, to process the integrity status and to determine the remaining lifetime of each point of a pipeline on a sophisticated mapping platform. In particular, aspects of one or more non-limiting embodiments of the disclosure generally relate to pipeline in-line inspection data conversion to integrate different pipeline inspection (In-Line Inspection (ILI)) reports into one standard platform.

### BACKGROUND

Corrosion of metal is a long-standing historical and global problem in a wide range of industries, and the oil and gas industry is not an exception. Pipeline operators are faced with many questions about the presence, location, and severity of corrosion in their oil and natural gas pipeline systems. In particular, pipeline operators need easy and centralized access to comprehensive pipeline integrity information, from many different sources, to accurately assess the integrity of each point of a pipeline and deploy the results of such assessment efficiently and effectively.

However, there are several ILI vendors who each provide different pipeline inspection ILI reports. There is a need to standardize all of these different reports to be able to process them to populate the Inspection ILI results and upload them in one standard platform.

### SUMMARY

Illustrative, non-limiting embodiments of the present disclosure address the above disadvantages and other disadvantages not described above. Also, a non-limiting embodiment is not required to overcome the disadvantages described above, and an illustrative, non-limiting embodiment may not overcome any of the problems described above.

Aspects of one or more example embodiments allow a user to access databases to access information needed to comprehensive pipeline integrity analysis in an In-Line Inspection (ILI) platform. In particular, aspects of one or more example embodiments integrate various databases to allow easy access and centralized storage of all needed information for pipeline integrity assessment, regardless of ILI service provider, to deploy the results, for example, in an ILI module of a pipeline integrity application, or in an augmented reality platform.

Aspects of one or more example embodiments may include a conversion tool and a standard to standardize any In-Line Inspection (ILI) report to be uploaded in a Pipeline integrity platform to further steps to determine the internal and external corrosion rate in the oil and gas pipeline.

Aspects of one or more example embodiments may integrate different pipeline inspection ILI reports of different formats into one standard platform to facilitate comprehensive ILI analysis in one standard platform.

Aspects of one or more example embodiments may include data conversion, transferring, standardization and making data ready to be uploaded in a standard ILI data process platform.

Aspects of one or more example embodiments may standardize the domain range of pipeline ILI inspection entities including but not limited to Pipe joint manufacturing type, Orientation of anomalies in standard units, features domain range, anomalies domain range, etc. all in one platform.

Aspects of one or more example embodiments may provide a method including collecting, by a processor, In-Line Inspection (ILI) pipeline inspection reports having different formats; converting, by the processor, the different In-Line Inspection (ILI) pipeline inspection reports into one standard platform; and generating, by the processor, an integrated pipeline data user interface using the one standard platform.

Additional embodiments will be set forth in the description that follows and, in part, will be apparent from the description, and/or may be learned by practice of the presented embodiments of the disclosure.

### BRIEF DESCRIPTION OF THE DRAWINGS

Features, advantages, and significance of non-limiting embodiments of the disclosure will be described below with reference to the accompanying drawings, in which like signs denote like elements, and wherein:

FIG. 1A shows a process flow diagram to call an ILI data set and convert log distance of pipeline features and geographic information (spatial data) to a standard WGS1984 data model (World Geodetic System (WGS)), according to a non-limiting embodiment;

FIG. 1B shows a list of all detectable features and its domain range including abbreviations in pipeline integrity and ILI terminology according to a non-limiting embodiment;

FIG. 1C shows a process to categorize and standardize pipeline features and pipeline detectable facilities according to a non-limiting embodiment;

FIG. 1D shows a process flow diagram to convert joint length, manufacturing type domain range and longitudinal seam weld orientation into standard units and ID names according to a non-limiting embodiment;

FIG. 1E shows a process flow diagram to convert facilities orientation, reading pipeline wall thickness either from ILI or a pipeline segmentation data sheet, and to standardize the distances to upstream and downstream girth welds and also surface location of metal loss corrosions according to a non-limiting embodiment;

FIG. 1F shows a process flow diagram to standardize and convert an ILI data set according to dimension of metal loss corrosions and to finalize an ILI data set to be uploaded in any platform according to a non-limiting embodiment;

FIG. 2 is a diagram of an example environment in which systems and/or methods according to one or more embodiments may be implemented;

FIG. 3 is a diagram of example components of a device according to an embodiment;

FIG. 4 shows an illustration of parameters describing location, orientation, and dimension of a metal loss feature in In-Line Inspection (ILI) suite software according to a non-limiting embodiment;

FIG. 5 shows an illustration of metal loss feature log distance of starting point, length and circumferential width with respect to flow direction in In-Line Inspection (ILI) suite software according to a non-limiting embodiment;

FIG. 6 shows an illustration of the definition of depth of metal loss corrosion features and wall thicknesses according to a non-limiting embodiment;

FIG. 7 shows a list of descriptive data for every single corrosion metal loss feature to be used in filtering and sorting of features along the pipeline;

FIG. 8A shows a left side of a spreadsheet as a system standard data entry format for all kinds of ILI reports and service providers according to a non-limiting embodiment; and

FIG. 8B shows a right side of a spreadsheet as a system standard data entry format for all kinds of ILI reports and service providers according to a non-limiting embodiment.

### DETAILED DESCRIPTION

The following detailed description of example non-limiting embodiments refers to the accompanying drawings. The same reference numbers in different drawings may identify the same or similar elements.

The matters defined in the description, such as detailed processes and elements, are provided to assist in a comprehensive understanding of the example embodiments. However, it is apparent that the example non-limiting embodiments can be practiced without those specifically defined matters. Also, well-known functions or constructions are not described in detail since they would obscure the description with unnecessary detail.

Further, one or more features or components of one embodiment may be incorporated into or combined with another embodiment (or one or more features of another embodiment). Additionally, in the flowcharts and descriptions of operations provided below, it is understood that one or more operations may be included or omitted, one or more operations may be added, one or more operations may be performed simultaneously (at least in part), and the order of one or more operations may be switched to convert any ILI data set to a standard ILI template to be used in any Pipeline integrity application(s).

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Also, in the present specification, it will be understood that when elements are “connected” or “coupled” to each other, the elements may be directly connected or coupled to each other, but may alternatively be connected or coupled to each other with an intervening element therebetween, unless specified otherwise.

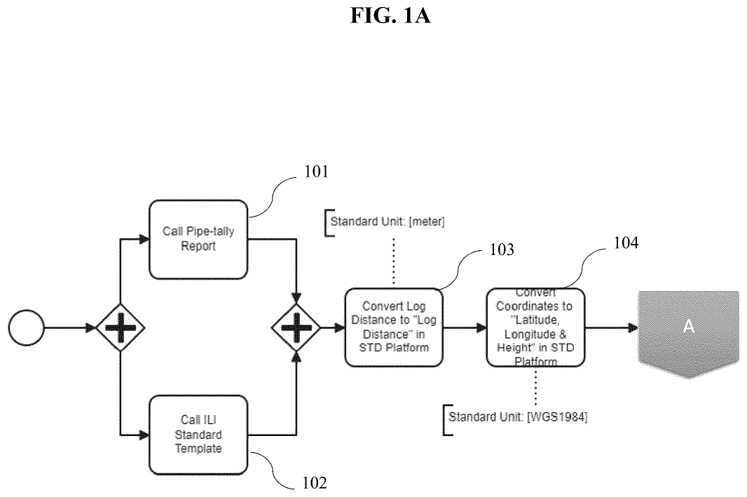

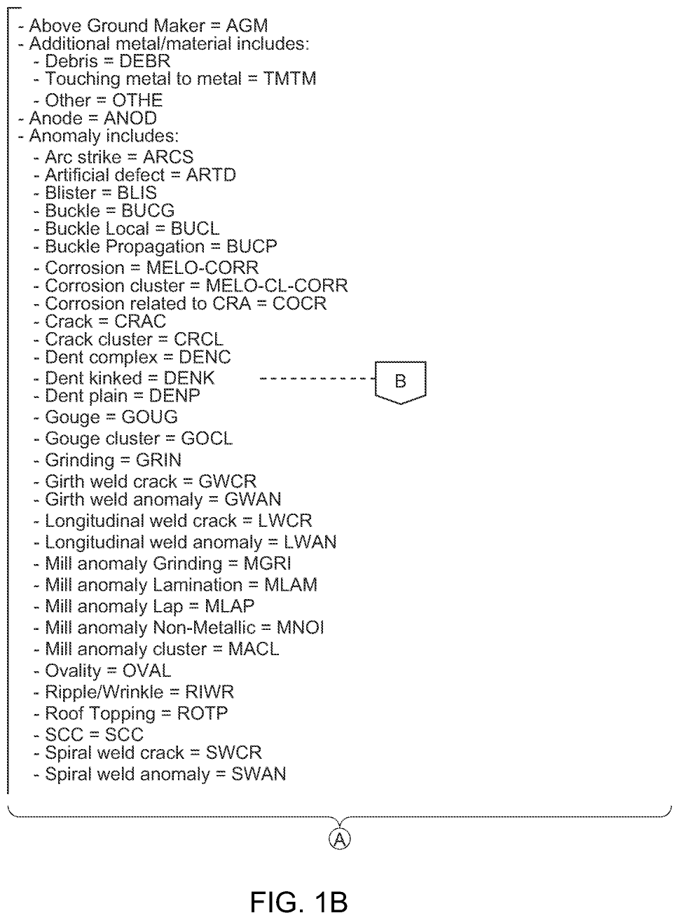

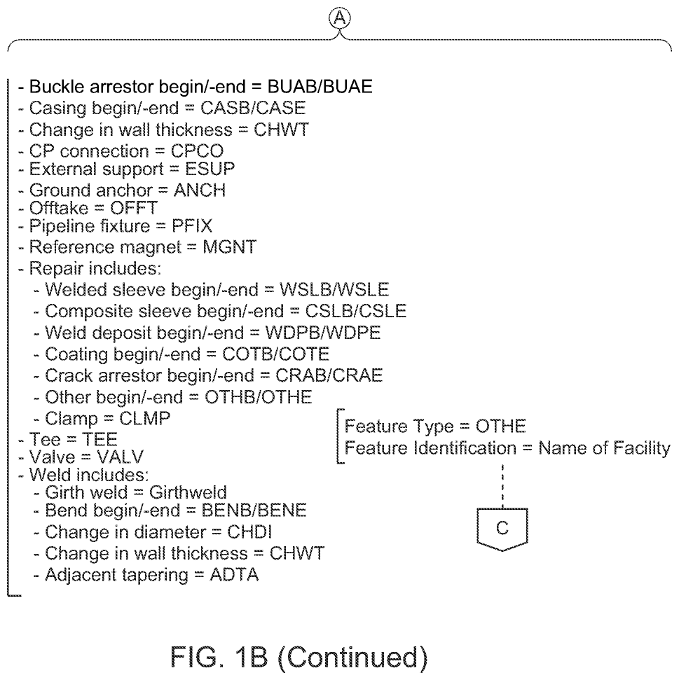

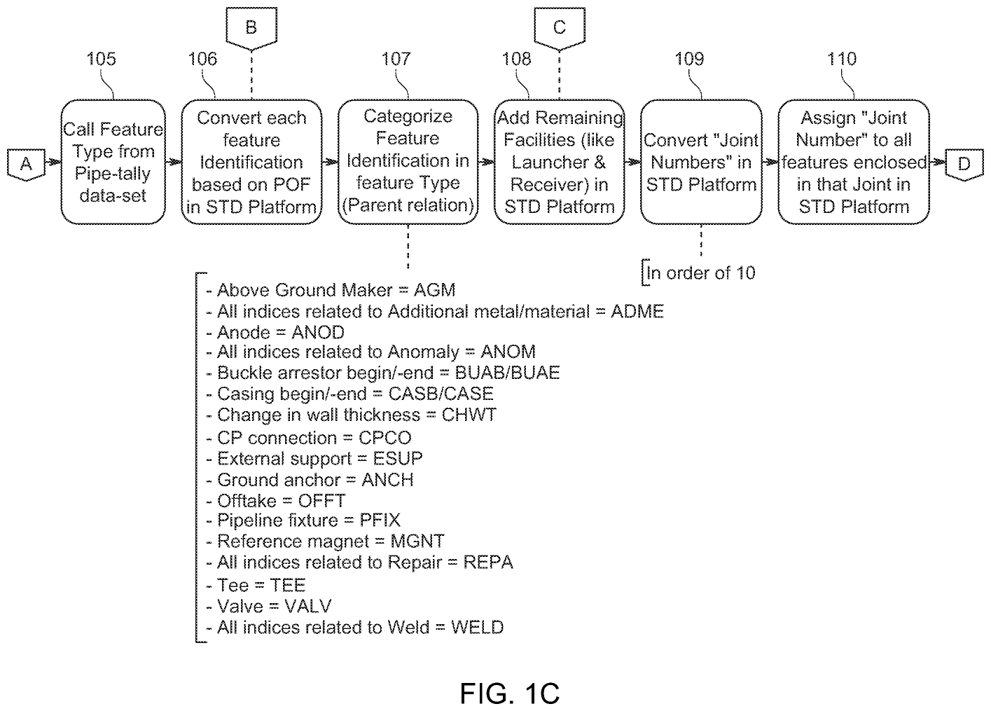

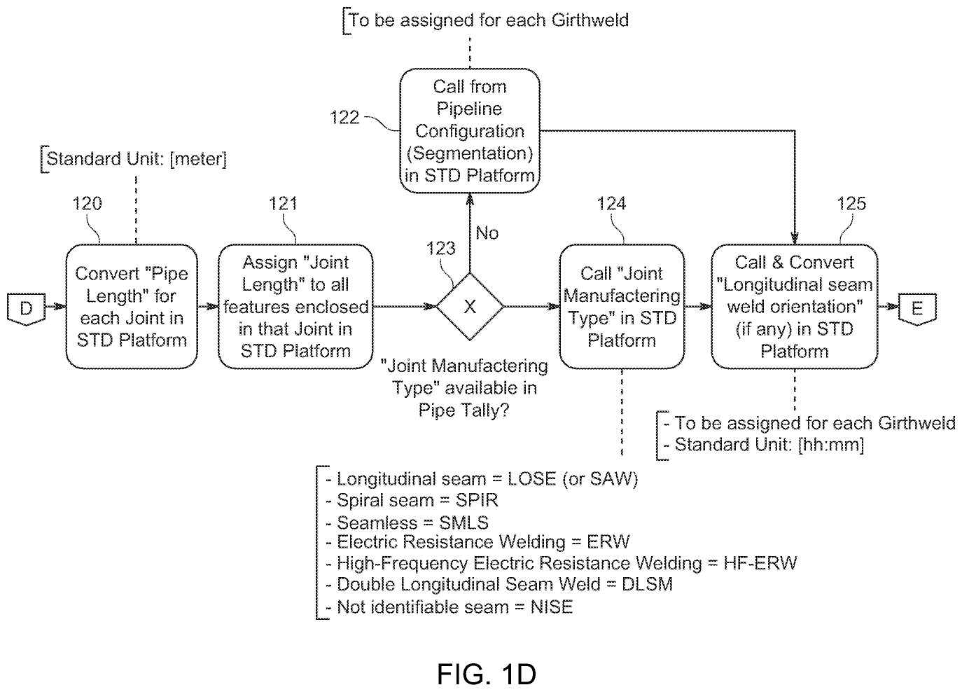

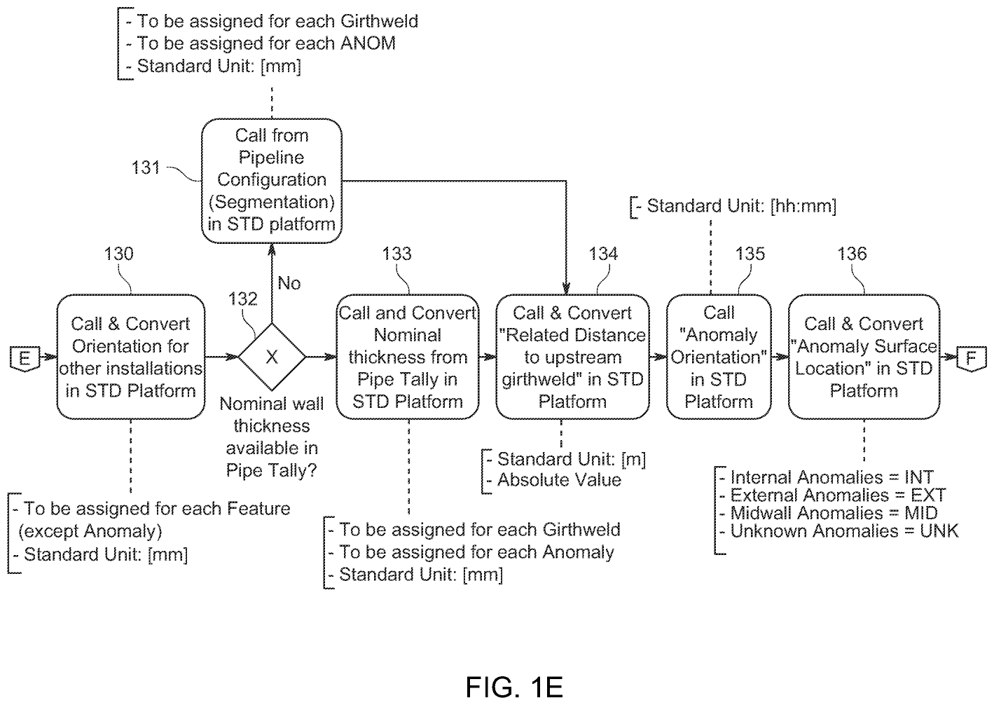

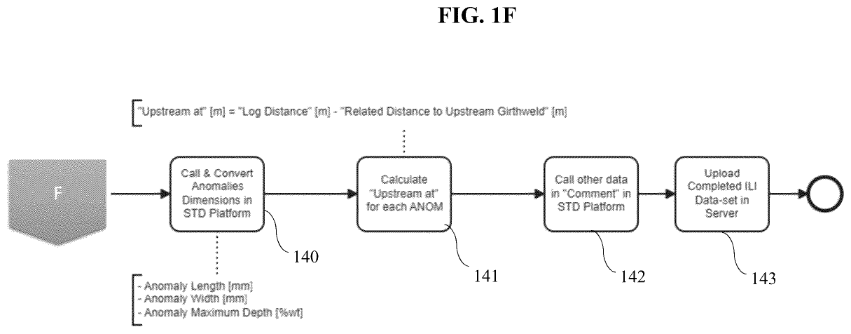

FIGS. 1A, 1B, 1C, 1D, 1E, and 1F show process flow diagrams according to a non-limiting embodiment.

FIG. 1A shows a process flow diagram to call an ILI data set and convert log distance of pipeline features and geographic information (spatial data) to a standard WGS1984 data model (World Geodetic System (WGS)), according to a non-limiting embodiment.

FIG. 1B shows a list of all detectable features and its domain range including abbreviations in pipeline integrity and ILI terminology according to a non-limiting embodiment.

FIG. 1C shows a process to categorize and standardize pipeline features and pipeline detectable facilities according to a non-limiting embodiment.

FIG. 1D shows a process flow diagram to convert joint length, manufacturing type domain range and longitudinal seam weld orientation into standard units and ID names according to a non-limiting embodiment.

FIG. 1E shows a process flow diagram to convert facilities orientation, reading pipeline wall thickness either from ILI or a pipeline segmentation data sheet, and to standardize the distances to upstream and downstream girth welds and also surface location of metal loss corrosions according to a non-limiting embodiment.

FIG. 1F shows a process flow diagram to standardize and convert an ILI data set according to dimension of metal loss corrosions and to finalize an ILI data set to be uploaded in any platform according to a non-limiting embodiment.

A non-limiting embodiment consistent with FIGS. 1A, 1B, 1C, 1D, 1E, and 1F may provide an interface that allows access to a system used to collect all In-line inspection reports in one standard platform. A non-limiting embodiment consistent with FIGS. 1A, 1B, 1C, 1D, 1E, and 1F may, among other advantages, allow a pipeline integrity engineer to convert and translate all data fields in an ILI report to a standard platform to be used in next steps of pipeline integrity analysis. Further, a non-limiting embodiment consistent with FIGS. 1A, 1B, 1C, 1D, 1E, and 1F may, include Function Modules that can be used to process a Pipeline ILI inspection report to a standard Master Inspection platform along with other pipeline integrity analysis (see e.g., cross-referenced related applications identified above).

A non-limiting embodiment may a part of a whole integrated process, which includes aspects of U.S. patent application Ser. No. 17/942,712, PCT/IB2021/053901, and U.S. Provisional Application No. 62/989,065. A non-limiting embodiment may improve the functioning of a computer, or improve another technology or field, by standardizing input data from different Pipeline integrity application(s). A non-limiting embodiment, as explained in detail with references to Tables 5-20 below, may provide a database model and solution for this challenge of standardizing input data from different Pipeline integrity application(s) and, thus, improve computer capabilities.

By way of illustration, there are several ILI vendors who provide Pipeline inspection ILI reports. All of these reports need to be standardized to be able to process them to populate the Inspection ILI results and upload them in one standard platform.

For instance, the below data sets may be available for further assessment:
The inspection results issued on a quality certificate In-line inspection data set (subject of a non-limiting embodiment),
Approved tool validation reports, and
Approved results verification (pipeline dig-up verification) forms.

In general, a quality ILI report is referenced to inspection results of a specific pipeline. Therefore, the transfer of the quality data on the standard platform is a necessary action prior to any further ILI analysis.

When transferring the quality data of an ILI run with reference to a standard platform or system, the data can be automatically uploaded to an inspection lot for a pipeline.

Alternatively, a user can use the functions to transfer data to any other desired inspection software or augmented reality platforms. Using the latter function, a user can transfer the quality data prior to any ILI assessment to a standard inspection.

FIGS. 1A, 1B, 1C, 1D, 1E, and 1F show a complete process flow diagram for ILI data conversion to any standard pipeline integrity platform or software according to a non-limiting embodiment.

According to a non-limiting embodiment, an ILI conversion sub-module may be implemented. If the ILI result is not acceptable (above steps for tool performance validation and results verification), the ILI dataset cannot be used, and it needs to be repeated.

Unless specified otherwise, the formulation for acceptable data loss for magnetic tools may be: the maximum acceptable sensor loss (primary sensors) and/or data loss is 3% and continuous loss of data from more than three adjacent sensors or 25 mm circumference (whichever is smallest) is not acceptable.

Unless specified otherwise, the formulation for acceptable data loss for Ultrasonic (UT) Test based ILI tools may be: the maximum acceptable sensor and/or data loss is 3% and the maximum allowable signal loss due to other reasons (e.g., echo loss) is 5%, whereby continuous loss of data from more than two adjacent transducers or 25 mm circumference (whichever is smallest) is not acceptable.

For all technologies, an alternative methodology can be to define data loss based on the required probability of detection (POD) of a specific defect like: the POD of an anomaly with minimum dimensions for a minimum percentage of the pipeline surface and pipeline length. E.g., an anomaly with length (L)≥20 mm, width (W)≥20 mm, depth (d)≥20% (or d≥1 mm for UT) in the pipeline may be detected with a POD≥90% for ≥97% of the pipeline surface and ≥97% of the pipeline length.

The tool operational data statement may indicate whether the tool has functioned according to specifications and may detail all locations of data loss and where the measurement specifications are not met. When the specifications are not met (e.g., due to speed excursions, sensor/data loss, etc.), the number and total length of the sections may be reported with possible changes of accuracies and certainties of the reported results.

A non-limiting embodiment may check the below items:
Sensor loss, Percentage of continuous loss of data and number of loss sensors,
Magnetization level, Percentage of off-spec magnetization level (upper and lower than acceptable window),
Temp. gradian, to be checked with IOW (pipeline Integrity Operating Window),
Tool top position diagram, to compare this report with sensor loss plot, and
Operation parameters and Battery life, to check the level of battery when a pig is received in Receiver.

The measurement capabilities of non-destructive examination techniques depend on the geometry of the metal loss anomalies. These metal loss anomaly classes have been defined as shown in Table 1 below to allow a proper specification of the measurement capabilities of the intelligent pig. Each anomaly class permits a large range of shapes. Within that shape a reference point is defined at which the POD is specified.

An even distribution of length, width and depth may be assumed for each anomaly dimension class to derive a statistical measurement performance on sizing accuracy.

The reference point/size in Table 1 is the point/size at which the POD is specified.

TABLE 1

| | | Reference point/size for |
|---|---|---|
| Anomaly dimension class | Definition | the POD in terms of l × w |
| General: | {[w ≥ 3A] and [l ≥ 3A]} | 4A × 4A |
| Pitting: | {([1A ≤ w < 6A] and [1A ≤ l < 6A] and | 2A × 2A |
| | [0.5 < l/w < 2]) and not | |
| | ([w ≥ 3A] and [l ≥ 3A])} | |
| Axial grooving: | {[1A ≤ w < 3A] and [l/w ≥ 2]} | 4A × 2A |
| Circumferential grooving: | {[l/w ≤ 0.5] and [1A ≤ l < 3A]} | 2A × 4A |
| Pinhole: | {[0 mm < w < 1A] and[0 mm < l < 1A} | Minimum dimensions tobe |
| | | further defined by |
| | | Contractor, see table A3-2 |
| Axial slotting*: | {[0 mm < w < 1A] and [l ≥ 1A]} | 2A × ½A |
| Circumferential slotting*: | {[w ≥ 1A] and [0 mm < l < 1A]} | ½A × 2A |

The * in Table 1 above indicates that anomalies with a width <1 mm are defined as crack or crack-like which might or might not be metal loss.

Resolution of Measurement Parameters

The following units and resolution may be used for the measurement parameters:
Log distances, 0.001 m,
Feature length and width, 1 mm,
Feature depth, 0.1 mm or 1%,
Reference wall thickness, 0.1 mm or 1%,
Orientation, 0.5° or 1 minute,
Estimated Repair Factor (ERF), 0.01 (Estimated Repair Factor refers to the ratio of the pipeline design pressure to the “safe maximum pressure” as determined by an analysis criterion (e.g. ASME B 31G, RSTRENG). This determines whether the anomaly meets specified acceptance criteria),
Magnetic field strength (H), 0.1 kA/m,
Magnetic flux density (B), 0.1 T (Tesla),
Axial sampling distance, 0.1 mm,
Circumferential sensor spacing, 0.1 mm,
Tool speed, 0.1 m/s,
Temperature, 1° C.,
Pressure, 0.01 MPa, and
Global Position Co-ordinates, 0.001 m.

Input Data Set

According to a non-limiting embodiment, as shown in FIG. 1A, at operation 101, a pipe-tally report is called. Operation 101 includes the process to upload received ILI data from ILI vendor(s) and includes all required data fields from an ILI data set.

At operation 102, a Standard ILI template is called. Operation 102 includes downloading a reference and standard ILI data format. Regardless of the ILI report and the ILI service vendor, this operation is to standardize the data set. This template has been prepared based on a Pipeline Operator Forum (POF) standard and each header refers to a particular category of information.

According to a non-limiting embodiment, the pipe tally report may be a listing of all pipeline component features and anomaly features and may be reported in accordance (including terminology) with the report structure as shown by the Standard ILI template after conversion in Table 2, shown below:

TABLE 2
(Standard ILI template after conversion):

Log Distance [m]
Latitude [dd:mm:ss · fff]
Longitude [dd:mm:ss · fff]
Height WGS84 Datum [m]
Feature (Component/Anomaly)
Feature
Girth weld/Joint Nr.
Up stream weld at [m]
Joint/Component length [m]
Joint Manufacturing Type
Longitudinal seam weld
Nominal thickness * [mm]
Rel. dis. To upstream weld
Anomaly orientation [o'clock]
Surface location
Original length [mm]
Original width [mm]
Original max depth [%]
Comment
The * in Table 2 above indicates that, according to a non-limiting embodiment, nominal wall thickness and methodology comes from ILI data, and if it is not available from ILI data, this data comes from a pipeline segmentation and configuration database.

Fully assessed feature sheets may contain the following information to the full sizing specification:
Length of pipe joint and (when present) orientation of longitudinal or spiral seam at start and end of every joint,
Length and longitudinal or spiral seam orientation of the 3 upstream and 3 downstream neighboring pipe joints,
Log distance of metal loss feature,
Wall thickness of the pipe joints (up to the 3 upstream and 3 downstream joints),
Log distance of features (with location coordinates known) like magnet markers, fixtures, steel casings, tees, valves, etc. on the first three upstream and downstream pipe joints,
Distance of upstream girth weld to nearest, second and third upstream marker,
Distance of upstream girth weld to nearest, second and third downstream marker,
Distance of anomaly to upstream girth weld,
Distance of anomaly to downstream girth weld,
Orientation of anomaly,
GPS coordinates of anomaly if a mapping tool was used,
Anomaly description and dimensions, and
Internal/external/mid-wall indication.

According to a non-limiting embodiment, the pipe tally report may contain the following fields in the given sequence:

Log distance,
Up stream weld distance,
Joint length,
Feature type,
Feature identification,
Anomaly dimension classification,
Clock position,
Nominal t (of each joint or pipeline component, between girth welds),
Measured t* (see below),
Reference t,
Length of anomaly/feature,
Width of anomaly/feature,
d/t in % for Magnetic Flux Leakage (MFL) and d in mm or inch for UT,
Surface location: internal (INT), external (EXT), mid-wall (MID) or not applicable (N/A), see Column 14, Report structure,
GPS coordinates of features if geographical tool is used,
ERF, and
Comments.
If not specified otherwise, the average of the wall thickness measurements of undiminished sections is regarded to be representative for the pipe joint/component.

A non-limiting embodiment may serve as a high-level in-line-inspection specification and thereby will cover all pipeline and Pipeline ILI reports.

A non-limiting embodiment specifies the unique methodology to convert ILI reports (geometric measurement, pipeline mapping, metal loss, crack or other anomaly detection during their passage through steel pipelines). The tools may pass through the pipeline driven by the flow of a medium or may be towed by a vehicle or a cable. The tools may be automatic and self-contained or may be operated from outside the pipeline via a data and power link.

To upload ILI data into a standard platform it is necessary to have a proper system/platform to transfer and to translate the data and units and convert them to one standard platform for any further actions.

This process specifies the advised reporting requirement to a pipeline integrity team to be used for geometric measurement, pipeline mapping, metal loss, crack or other anomaly detection during the ILI process and reporting. In existing industry systems, an end user cannot import different types of ILI reports. It is a challenge to translate different columns in different reports. Moreover, in many cases the data fields need to be translated into a standard platform. For example, for defects orientation, some ILI service providers are reporting based on degree, others with o'clock orientation. Some companies report start and end point of defects and the deepest metal loss point, but others just report deepest location in general metal loss. Plus, clustering rules and defects interaction criteria are different in ILI companies, and it could be a challenge to understand and use them in other ILI modules like in analytical reports, Fitness-for-Service (FFS), Defect assessment, etc.

A non-limiting embodiment may serve as a generic and standard platform to translate and convert all types of ILI reports into a single standard platform for ILI.

For this challenge, industry needs an interim spreadsheet, to translate different ILI vendors to be able to import into a standard suite and to conduct further assessments.

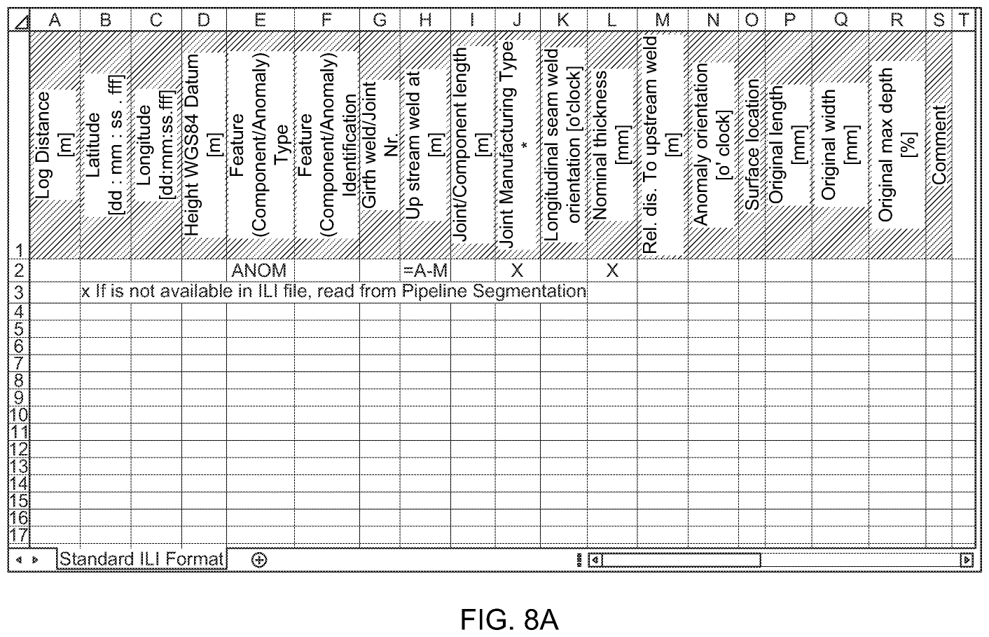

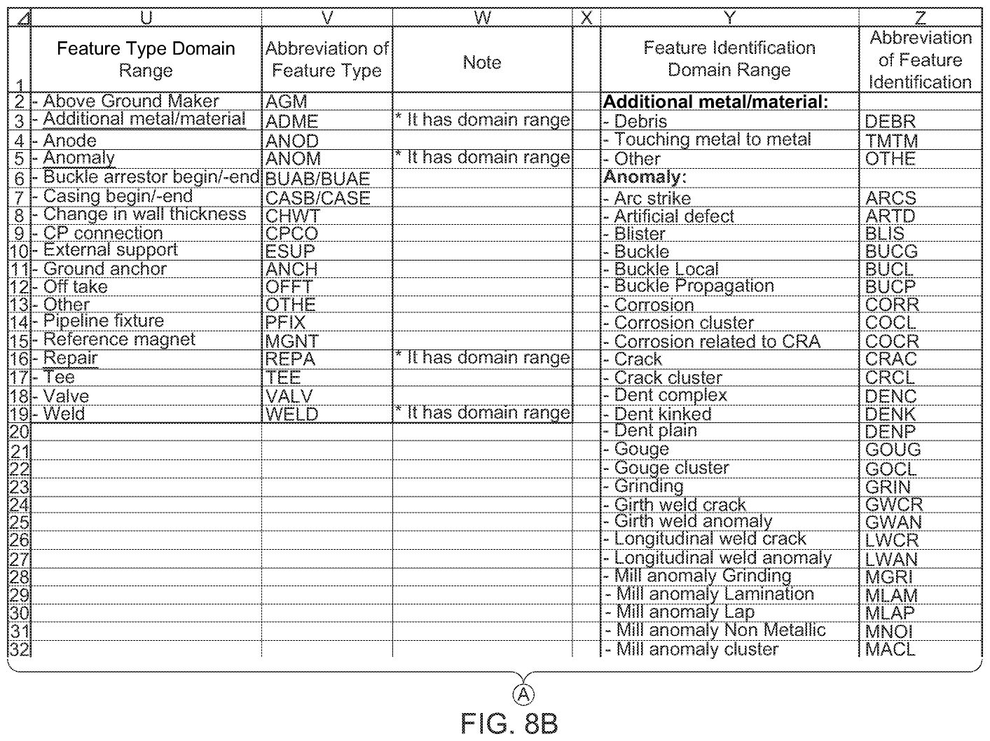

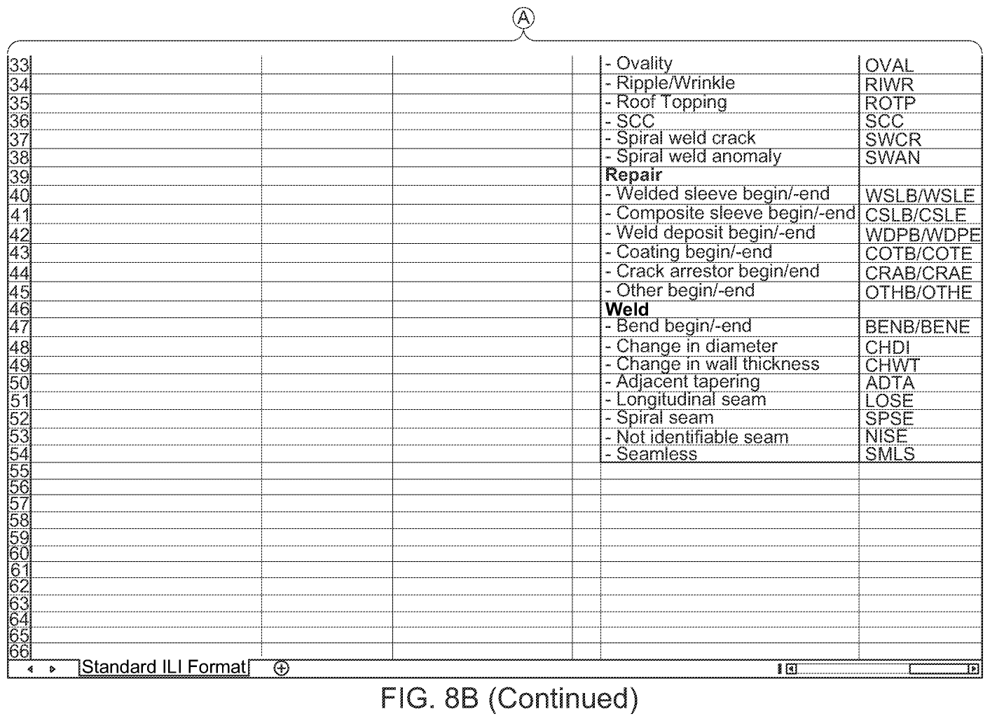

According to a non-limiting, as shown in FIG. 8A and FIG. 8B, it may be one spreadsheet (standard excel format) in comma-separated values (CSV) as a system standard data entry format for all kinds of ILI reports and service providers. FIG. 8A shows a left side of a spreadsheet as a system standard data entry format for all kinds of ILI reports and service providers according to a non-limiting embodiment. FIG. 8B shows a right side of a spreadsheet as a system standard data entry format for all kinds of ILI reports and service providers according to a non-limiting embodiment. However, non-limiting embodiments may use system standard data entry formats for all kinds of ILI reports and service providers other than those shown in FIG. 8A and FIG. 8B.

According to a non-limiting, this standard data entry form may be compatible with Pipeline Open Data Standard (PODS 7.0) data model.

A non-limiting embodiment may upload ILI data in a standard platform. It needs a proper system to transfer and translate the data and units and to convert them into one standard platform.

Operation 103 includes converting log distance to “log distance” in a standard platform. Operation 103 standardizes log distance in a required unit. This log distance may be references for all anomalies in further operations.

Operation 104 includes a process to convert any geo mapping coordinates to WGS1984 format. The World Geodetic System (WGS) is a standard for use in cartography, geodesy, and satellite navigation including GPS. This standard includes the definition of the coordinate system's fundamental and derived constants, the normal gravity Earth Gravitational Model (EGM), a description of the associated World Magnetic Model (WMM), and a current list of local datum transformations.

The latest revision is WGS 84 (also known as WGS 1984 ensemble):
EPSG:4326 for 2D coordinate reference system (CRS),
EPSG:4979 for 3D CRS,
EPSG:4978 for geocentric 3D CRS.

It is established and maintained by the United States National Geospatial-Intelligence Agency since 1984, and last revised in January 2021 (G2139frame realization). WGS 84 ensemble is static, while frame realizations have an epoch. Earlier schemes included WGS 72, WGS 66, and WGS 60. WGS 84 is the reference coordinate system used by the Global Positioning System.

As a CRS standard, and expressing by URN, urn:ogc:def:crs:EPSG::4326, it is composed of:
a standard reference ellipsoid model, named urn:ogc:defellipsoid:EPSG::7030;
and this ellipsoid is located a standard horizontal datum, named urn:ogc:defdatum:EPSG::6326.

After operation 104, the next step of the process is identified by arrow A in FIG. 1A and FIG. 1C.

FIG. 1B shows a list of all detectable features and its domain range including abbreviations in pipeline integrity and ILI terminology according to a non-limiting embodiment. As shown in FIGS. 1B and 1C, arrow B shows a relation between FIG. 1B and FIG. 1C.

FIG. 1C shows a process to categorize and standardize pipeline features and pipeline detectable facilities according to a non-limiting embodiment. As shown in FIG. 1C, operation 105 includes converting and translating all existing features to standard features and terminologies.

Operation 106 includes converting and translating all existing features identification to standard features and terminologies such as corrosion.

Operation 107 includes categorizing feature identification in a standard manner.

Operation 108 includes a sub-process to add other pipeline facilities and ancillaries like launcher, receiver, etc.

As shown in FIG. 1B and FIG. 1C, arrow C refers to a method of naming some unknown features in ILI Reports.

Operations 109 and 110 include standardizing joint numbers and their reference location in the entire process. In particular, operation 109 includes converting joint numbers into a STD platform. Operation 110 includes assigning joint numbers to all features enclosed in that joint into a STD platform.

After operation 110, the next step of the process is identified by arrow D in FIG. 1C and FIG. 1D.

Operation 120 includes converting pipe length for each joint into a STD platform. In the API 5L standard specification, the steel line pipe shall be delivered in accordance with the random length and approximate length in the order contract. In the API 5L specification 9.11.3.3 the tolerance for the pipe length is specified as below:
a. Unless other lengths agreed, (Length with less tolerances), random lengths shall be applied as the table 12.
b. Approximate lengths shall be delivered within a tolerance of +/−500 mm (+/−20 inch).

The common random length of the API 5L steel line pipe is designated at 6 m, 8 m, 9 m, 10 m and 12 m. The length also can be customized according to specific requirements.

Operation 120 includes standardizing the joint length based on standard unit (meter). Operation 121 is continuation of operation 120 and includes assigning the joint length to all features.

Operation 122 includes recalling required data from a segmentation process. “Pipeline Segment” means a section of a Carrier's pipeline, the limits of which are defined by two geographically identifiable points, that, because of the way that section of the Carrier's pipeline is designed and operated, must be treated as a unit for purposes of determining capacity. Segmentation is the process of defining pipe sectors with similar characteristics (external or internal) that can be used as units for integrity evaluation. Segmentation can be static—i.e., initially predefined —, or dynamic—i.e., adaptable to mechanical or external conditions.

Static segmentations use fixed distances defined arbitrarily (e.g., one mile) or it is defined by specific mechanical elements of particular interest such as valves. In static segmentation, there is considerable variability in the results of risk assessment and this may increase intervention costs due to unnecessary evaluations. Furthermore, critical zones can be hidden if risks are weighted throughout long segments.

In the dynamic segmentation, the length is not relevant as long the feature on which the segmentation is evaluated remains constant throughout the entire segment.

Operation 123 includes standardizing joint manufacturing type based on API 5L standard and domain range. If this data is not available in an ILI data set, the system will read this from a Pipeline segmentation table.

Operation 124 is a continuation of Operation 123 to include an acceptable domain range for joint manufacturing type.

Operation 125 includes standardizing seam weld orientation for each joint in the pipeline. The output will be utilized in a tool tolerances adds-on.

After operation 125, the next step of the process is identified by arrow E in FIG. 1D and FIG. 1E.

Operation 130 is similar to operation 125 but for pipeline ancillaries.

Operation 131 includes an alternative wall thickness, reading from a pipeline segmentation data set.

Operation 132 includes assigning a wall thickness for every joint along the pipeline.

Operation 133 includes another alternative to operation 131 if wall thickness is available in ILI data (most likely in Ultrasonic ILI data).

Operation 134 includes calculating the distance of each anomaly to an upstream girth weld.

Operation 135 includes standardizing orientation of a top left corner of each anomaly box in a flow direction.

Operation 136 includes determining a surface location of each metal loss anomaly. For example, it can be either Internal, External, Mid wall, Unknown.

After operation 136, the next step of the process is identified by arrow F in FIG. 1E and FIG. 1F.

Operation 140 includes determining the anomaly box size (length, width, depth).

Operation 141 includes calculating the location of upstream girth weld.

Operation 142 includes adding an extra comment from the ILI data set.

Operation 143 includes uploading a standard data set to the platform for further analysis.

Further Steps and Modules:

Sub-Module ILI Tool Operation Validation

The objective of In-Line Inspection (ILI) is to obtain data on the pipeline condition as part of the baseline and/or revalidation process. A key part of the process is verification of the ILI tool performance and an analysis process through the use of field verification.

The quality and consistency of data obtained from the field is important for statistical verification of the performance of the ILI processes. In many cases the Operator is only focused on confirmation of a reported feature rather than the performance of the overall inspection process. This process is to validate the process and performance of ILI tool.

This process specifies the requirements and a detailed method statement for ILI operational reports in the ILI suite. It covers the basic requirements for ILI reports such as Sensor loss plots, Magnetization level assessment, etc., as a supplementary assessment for a standard ILI platform.

This process specifies the advised operational and reporting requirements for tools to be used for geometric measurement, pipeline mapping, metal loss, crack or other anomaly detection during their passage through steel pipelines. The tools may pass through the pipeline driven by the flow of a medium or may be towed by a vehicle or cable. The tools may be automatic and self-contained or may be operated from outside the pipeline via a data and power link. But regardless of technique and brand of ILI tool, this process covers minimum acceptance criteria for ILI operation before any data evaluation.

This algorithm may be provided based on a Pipeline Operator Forum (POF) standard and a PODS database.

This process may serve as a generic in-line-inspection specification and thereby cannot cover all pipeline or pipeline operator specific issues. To support the pipeline operator in specifying/detailing some optional items in this process, the Information Technology (IT) team should be flexible for any change during runs for different pipeline cases.

From the previous process, we have an interim spreadsheet as standard platform to be translated from different ILI reports and vendor templates and also, we have captured most of analytical reports and assessments.

The tool specifications may be given. In addition, the following operational data may be provided, whereby each type of tool that has been used may be described separately:
Data sheet of used tool(s) with e.g., serial number, software version etc.,
The data-sampling frequency or distance,
The detection threshold,
The reporting threshold, normally taken at 90% POD if not specified otherwise,
A tool velocity plot over the length of the pipeline,
Optionally, a pressure and/or temperature plot over the length of the pipeline,
Defective transducer statistics and, in the case of ultrasonic pigs, echo loss statistics,
In the case of MFL tools, a plot of the magnetic field strength H in kA/m over the length of the pipeline measured at the inner surface of the pipe, and
A tool operational data statement that can be used to consider a re-run.

Sub-Module ILI Field Verification

An ILI project is not complete until the reported features have been verified in the field. The process which is followed in the field to achieve this is important as inappropriate inspection techniques in the field can invalidate an otherwise valid report.

Field verification of reported features has two important aspects as this helps confirm:
(1) The reported features confirming the condition of the line to the operator, which helps support any actions that may be taken, and
(2) The tool performance for use on other lines where dig verification is not possible.

It is necessary to determine the performance of the inspection, in order to conduct the required preventative maintenance plans with the certainty of risk required by the Operator. Factors of Safety (FOS) can only be used effectively if the tolerances being used to calculate the FOS actually match those provided in the inspection report or are more conservative in nature. It is not acceptable to use sizing tolerances that are not conservative, which means the actual measured dimensions are greater than those predicted even with the tool vendors tolerance added.

Most ILI suppliers will provide support for field verification activities. The ILI suppliers are not just interested in when the ILI tool has not performed to specification. They also need good quality field data to help verify the tool performance specifications for a range of feature types.

To achieve consistency with data collection it is necessary to set standards and protocols that must be followed.

This requires trained field personnel to gather the data with the required accuracy and competency so that the results can be relied upon. The techniques and equipment used must be tested and certified in calibration. The calibration and device tolerances must be taken into account when evaluating the results.

This process is to verify the results of ILI run and to accept the step to proceed further steps in the entire process.

Sub-Module ILI Correlation

Thus sub-module outputs a correlated ILI report based on field verification results. This output of this sub-module will be the final report to be assessed in this process.

Sub-Module Corrosion Morphology Change

This sub-module determines the dimension class and morphology of metal loss corrosions (pin-hole, pitting, General corrosion, axial slotting, axial grooving, circumferential slotting, circumferential grooving).

Sub-Module Tolerance Allocation Considering (Pipe Body and Hazardous Area)

This sub-module considers ILI tool tolerances which are different for pipe body and hazardous (HAZ) area.

ILI service provider reports the tolerances for Caliper and MFL tools as outlined in ILI tables. Typically, these tool tolerances are added to the measured dimensions of an anomaly when assessing its static strength. Fitness-for-Performance (FFP) assessments are performed in this process, once with, and once without, consideration of ILI tool tolerances.

An ILI company may classify features in accordance with the Pipeline Operators Forum (POF) specification based on their aspect ratio (width×length), prior to applying the appropriate tolerance.

Sub-Module Clustering

Following inline inspection of a pipeline, the interaction criterion used in subsequent defect assessment is agreed upon between the inspection vendor and the pipeline operator. The first process, referred to as “boxing”, is where a box is drawn around each feature. The second process, referred to as “clustering”, is a process to determine whether boxes located in close proximity to one another should be considered as a single corrosion feature. Finally, a decision has to be made on whether adjacent defect clusters will interact or not. Remaining strength predictions of the corroded pipeline will be very sensitive to the interaction criterion used and the method.

To date, most of the Pipeline Integrity and ILI software, work on corrosion assessment on studying isolated defects, primarily of similar depths. The failure pressure of an interacting defect will be lower than that for an isolated defect because it will interact with neighbouring defects. Both American Society of Mechanical Engineers (ASME) B31G and RSTRENG do not provide guidance for grouping and assessing metal loss defects that may interact. Some guidance is given in BS 7910 and DNVGL RP-F101 and, indeed, some pipeline operators have developed their own criterion for grouping defects. In general, existing guidance is based on limited empirical or semi-empirical derived methods that still require on judgment from the analyst.

This process has recognized that a robust method for grouping and assessing metal loss defects that may interact is required by a pipeline integrity engineer. According to a non-limiting embodiment, there is a sub-module in the software which enables a user to select interaction criteria (clustering rules) utilizing different dimension rules and also even material property to apply clustering in 2 different levels and to apply immediate and future integrity assessment based on new grouped sizes (New length, width and depth).

There is a unique option in this sub-module that enables a pipeline integrity engineer to increase sensitivity of clustering (select more conservative rule and level) in High Consequence Areas (HCA) and also in Unusual Sensitive Areas (USA).

Not only the clustering rule to be selected by the pipeline software user is an option for pipeline integrity engineer, but also selection of with and without applying Tolerances and also different standards (Original ASME B31G, Modified B31G, Shell92, DNVGL RP F101, Part B and DNVGL RP F101 Part A with Axial loading) are available options to be selected. Next to all, a user can filter specific location of pipeline or specific orientation for detail studies.

Sub-Module ILI Analytical Study

This step specifies the requirements and a detailed method statement for analytical reports in the ILI suite. It covers the basic analytical reports for ILI reports such as distribution plots, high level analysis, distribution of orientation for different category of defects, etc. all based on a standard ILI platform.

An ILI suite for pipelines may be very comprehensive, interactive client software that provides access to the Inspection Data, database information and complete details of the inspection.

This step may provide thorough functionality to manage and maintain the pipeline facility and to generate any required reports, charts or graphs regardless of ILI service provider and any brand.

An ILI suite for pipelines may feature:
Access to all Inspection Data,
Visualization of Inspection Data in various display formats with scroll functions,
Access to database files for all features, fittings, markers, welds, bends and any other pipeline installation detected by the tool or input by the Operator,
Sorting and filtering functions to manipulate the data,
Pipe Tally including all database information,
List functions to design, generate, sort and filter client specific lists,
Weld and feature Location Sheet for any selected feature,
Statistical functions for anomaly or feature distribution or classification,
On-screen search, zoom and scroll functions,
Client specific calculators for remaining strength of pipe,
Client specific methods to calculate defect interaction,
Symbolic Pipe View to aid in data navigation, and
Printing and Exporting functions.

From a previous step there is an interim spreadsheet as standard platform to be translated from different ILI reports and vendor templates. After this translation (conversion), a system engine is able to start further analytical assessments for a selected data set as per this method statement.

All of these analyses will be based on standard spreadsheet (standard excel format) in CSV as a base for all types of ILI reports.

It is important to have consistent and reliable standards. The anomalies must be accurately measured in length, width and depth in ILI reports.

When evaluating anomalies, it is very important to understand the extent of the anomaly and how its interaction with adjacent anomalies is accounted for in the report. A best practice is to measure the distance from the upstream girth weld and to paint a box equivalent to the reported dimensions, including the tolerances and taking into account the interaction (of the boxes in a cluster).

The accuracy of the inspection can then be easily recognized and documented by photography. The different types of anomalies are evaluated against the appropriate standard or code for that specific type of anomaly include (but are not limited to):

ASME B31.G—Manual for Determining the Remaining Strength of Corroded Pipelines: A Supplement to ASME B 31 Code for Pressure Piping; published by ASME International,
Rstreng-5 (Modified ASME B31 G)—Pipeline Research Council International (PRCI) contract PR-218-9304, Continued validation of Rstreng″ (December 1996),
DNV RP-F101,
Shell 92,
BS 7910 Annex G,
American Petroleum Institute (API) 579 (Sections 4-5),
Cracks,
API 579 (Section 9),
BS7910, and
DNV pressure calculation.

The interaction rules to be used need to be completed in previous steps.

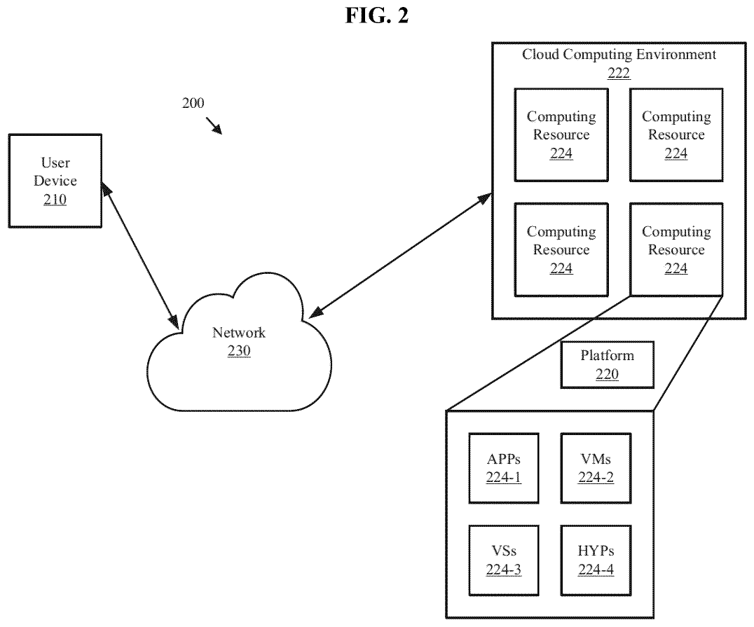

FIG. 2 is a diagram of an example environment 200 in which systems and/or methods, described herein, may be implemented. As shown in FIG. 2, environment 200 may include a user device 210, a platform 220, and a network 230. Devices of environment 200 may interconnect via wired connections, wireless connections, or a combination of wired and wireless connections. In embodiments, any of the functions and operations described herein may be performed by any combination of elements illustrated in FIG. 2.

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of receiving, generating, storing, processing, and/or providing information. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 may not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, a cluster of computing devices, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

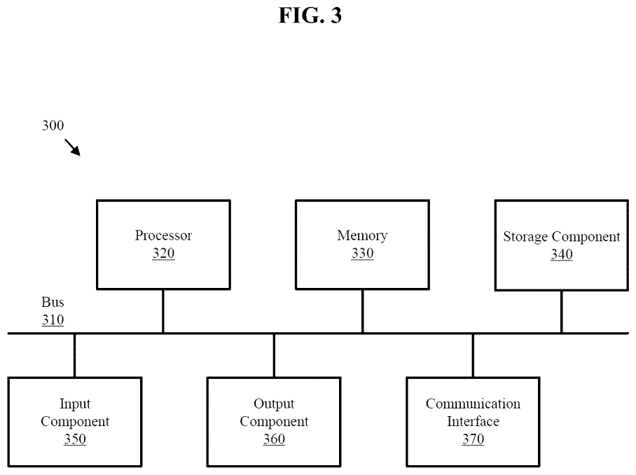

FIG. 3 is a diagram of example components of a device 300, according to a non-limiting embodiment. Device 300 may correspond to user device 210 and/or platform 220. As shown in FIG. 3, device 300 may include a bus 310, a processor 320, a memory 330, a storage component 340, an input component 350, an output component 360, and a communication interface 370.

Bus 310 includes a component that permits communication among the components of device 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

In non-limiting embodiments, any one of the operations or processes described herein may be implemented by or using any one of the elements illustrated in FIGS. 2-3.

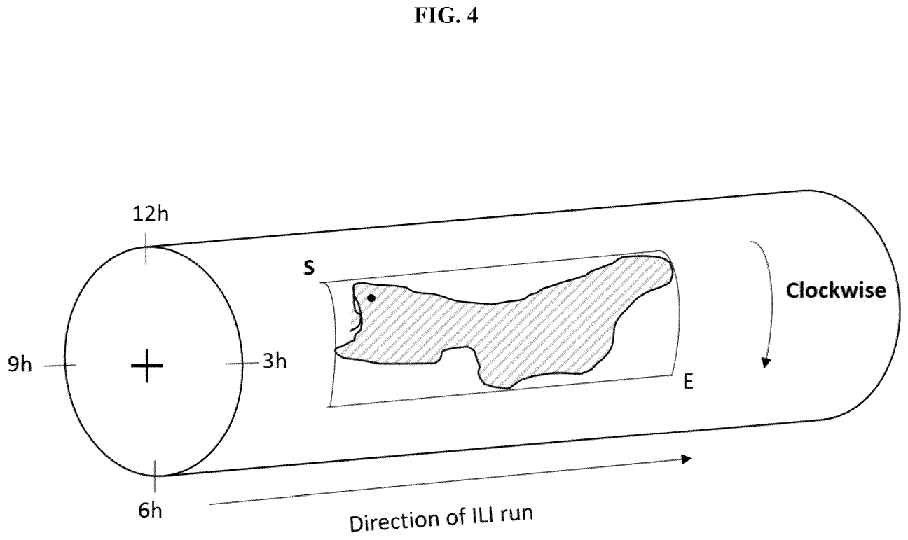

FIG. 4 shows an illustration of parameters describing location, orientation, and dimension of a metal loss feature in In-Line Inspection (ILI) suite software according to a non-limiting embodiment.

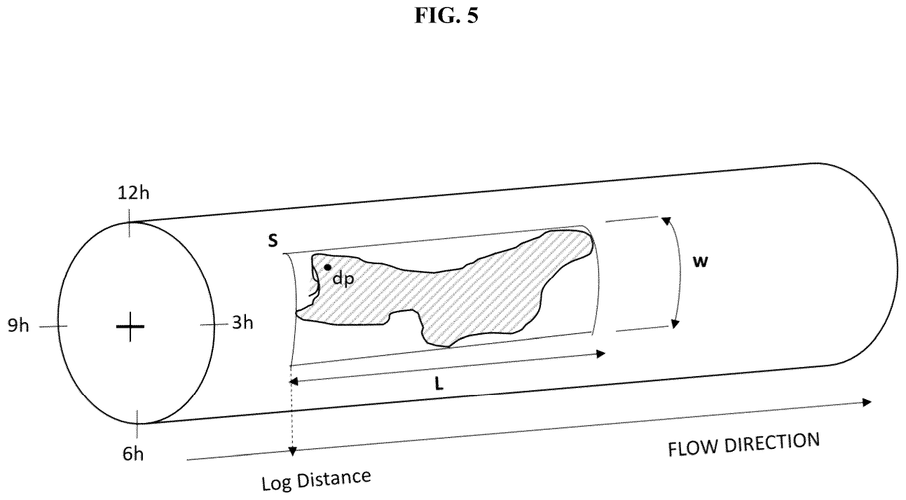

FIG. 5 shows an illustration of metal loss feature log distance of starting point, length and circumferential width with respect to flow direction in In-Line Inspection (ILI) suite software according to a non-limiting embodiment.

The location of an anomaly is given with S-Log distance and S-Position as described in FIG. 5.

The length of a metal loss anomaly is given by its projected length on the longitudinally axis of the pipe, the width of a metal loss anomaly is given by its projected length on the circumference of the pipe. The depth of a metal loss anomaly is determined by maximum wall loss (dP).
S-Log=Log distance [m]
S-Position=o'clock position [h]
L=Anomaly length [mm]
W=Anomaly width [mm]
t=reference wall thickness [mm]
d=anomaly depth [mm]
rwt=remaining wall thickness [mm]
TH_R=reporting threshold [% of t]
dP=deepest point of a metal loss anomaly
t(calc)=calculated wall thickness [mm]

The ‘Magnetic Flux Leakage (MFL) Method’ accesses the relative depth d/t which is calculated on the basis of the tool calibration.

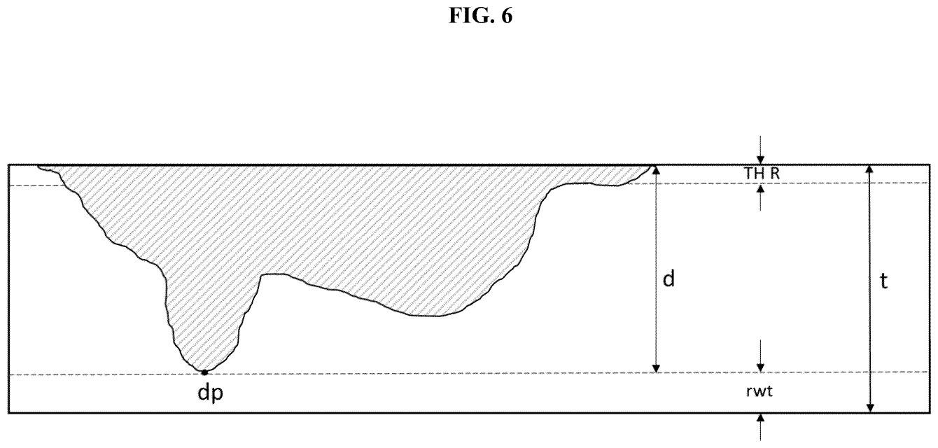

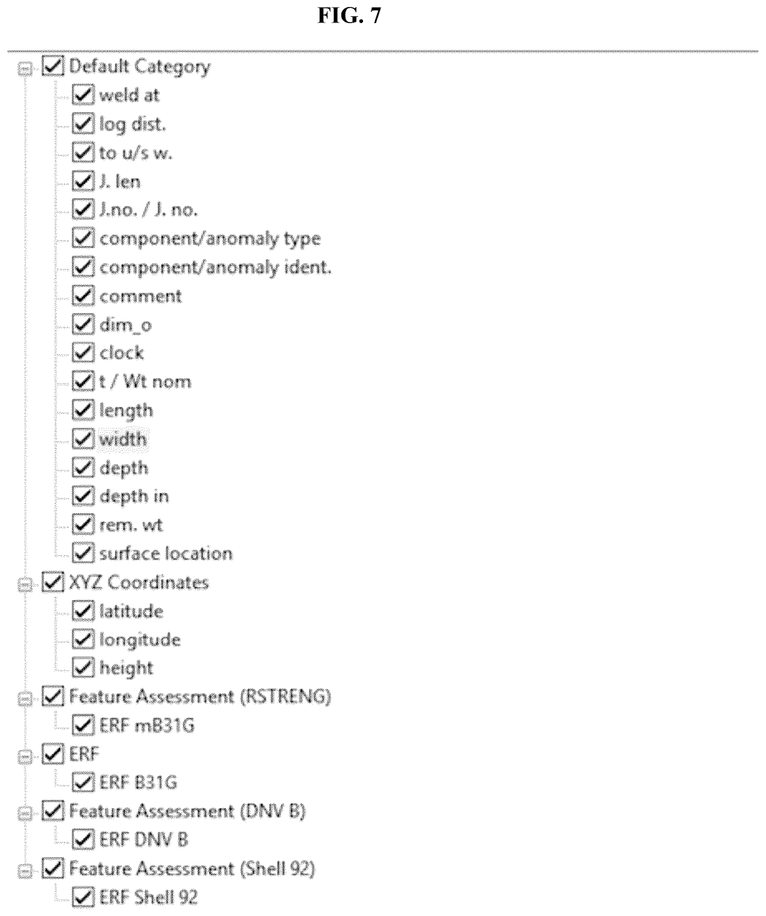

FIG. 6 shows an illustration of the definition of depth of metal loss corrosion features and wall thicknesses according to a non-limiting embodiment.

Both values d/t and t (calc) are independent and specified separately with concern to their accuracy.

Important consequence: For field comparison measurements it must be ensured that the reference wall thickness surrounding the anomaly is used to calculate the relative depth of the anomaly in order to apply the specified MFL depth accuracy. If this comparison will be based on the MFL calculated wall thickness the specified accuracy interval is enlarged following the law of error, i.e., the relative errors specified for the wall thickness and the relative anomaly depth must be summarized.

FIG. 7 shows a list of descriptive data for every single corrosion metal loss feature to be used in filtering and sorting of features along the pipeline.

Sub-Module ILI Re-Run

If the ILI result is not acceptable (above steps for tool performance validation and results verification), the ILI dataset cannot be used, and it needs to be repeated.

Unless specified otherwise, the formulation for acceptable data loss for magnetic tools may be: The maximum acceptable sensor loss (primary sensors) and/or data loss is 3% and continuous loss of data from more than three adjacent sensors or 25 mm circumference (whichever is smallest) is not acceptable.

Unless specified otherwise, the formulation for acceptable data loss for UT tools may be: The maximum acceptable sensor and/or data loss is 3% and the maximum allowable signal loss due to other reasons (e.g., echo loss) is 5%, whereby continuous loss of data from more than two adjacent transducers or 25 mm circumference (whichever is smallest) is not acceptable.

ILI Data Set Validation

For all technologies, an alternative methodology can be to define data loss based on the required POD of a specific defect like:

The POD of an anomaly with minimum dimensions for a minimum percentage of the pipeline surface and pipeline length. E.g., an anomaly with L≥20 mm, W≥20 mm, d≥20% (or d≥1 mm for UT) in the pipeline may be detected with a POD≥90% for ≥97% of the pipeline surface and ≥97% of the pipeline length.

The tool operational data statement may indicate whether the tool has functioned according to specifications and may detail all locations of data loss and where the measurement specifications are not met. When the specifications are not met (e.g., due to speed excursions, sensor/data loss, etc.), the number and total length of the sections may be reported with possible changes of accuracies and certainties of the reported results. A non-limiting embodiment may assess the below ILI tool operation reports:
Sensor loss, Percentage of continuous loss of data and number of loss sensors,
Magnetization level, Percentage of off-spec magnetization level (upper and lower than acceptable window),
Temp. gradian, to be checked with IOW (pipeline Integrity Operating Window),
Tool top position diagram, to compare this report with sensor loss plot, and
Operation parameters and Battery life, to check the level of battery when pig is received in Receiver.

ILI Distribution Charts

According to a non-limiting embodiment, software may have the ability to show the columns in short text (abbreviations). According to a non-limiting embodiment, the output includes 23 very practical charts for the distribution of internal and external metal loss corrosion and other anomalies along the pipeline route and in different segments. One non-limiting embodiment showing such 23 charts is shown below in Table 3.

TABLE 3

| Chart | | | Sub X-axis | | | X-axis |
|---|---|---|---|---|---|---|
| Nr. | Title of Chart | X-Axis Title | Title | Y-axis Title | Z-axis Title | Domain |
| 1 | Line pipe | Joint | | Number of | | COWL |
| | distribution | manufacturing | | joints | | COWH |
| | by Joint | type | | | | CW |
| | manufacturing | | | | | DSAW |
| | type | | | | | LFW |
| | | | | | | LW |
| | | | | | | HFW |
| | | | | | | SPIRAL |
| | | | | | | ERW |
| | | | | | | ERW-HF |
| | | | | | | SEAMLESS |
| 2 | Line pipe | Number of | | Nominal Wall | | |
| | distribution by | joints | | thickness [mm] | | |
| | wall thickness | | | | | |
| 3 | Line pipe | Number of | | Joint | | |
| | distribution | joints | | Length [m] | | |
| | by joint length | | | | | |
| 4 | Anomaly | | | | | External |
| | distribution | | | | | Internal |
| | by Surface | | | | | Mid wall |
| | location (Int., | | | | | Unknown |
| | Ext., Mid wall, | | | | | |
| | Unknown) | | | | | |
| 5 | Overall Corrosion | | | | | GENE (General) |
| | Metal loss | | | | | PINH (Pin-hole) |
| | distribution by | | | | | PITT (Pitting) |
| | Dimension class | | | | | AXGR |
| | | | | | | (Axial Grooving) |
| | | | | | | AXSL |
| | | | | | | (Axial Slotting) |
| | | | | | | CIGR |
| | | | | | | (Circum. Grooving) |
| | | | | | | CISL |
| | | | | | | (Circum. Slotting) |
| 6 | Dimension | Segment No. | ILI 1 | % | GENE (General) | Dimension |
| | Class Change | | ILI 2 | | PINH (Pin-hole) | Class Change |
| | over time (ILI | | ILI 3 | | PITT (Pitting) | over time (ILI |
| | Runs) for | | ILI 4 | | AXGR | Runs) for |
| | Internal & | | . . . | | (Axial Grooving) | Internal & |
| | External | | . . . | | AXSL | External |
| | metal loss | | . . . | | (Axial Slotting) | metal loss |
| | | | ILI n | | CIGR | |
| | | | | | (Circum. Grooving) | |
| | | | | | CISL | |
| | | | | | (Circum. Slotting) | |
| 7 | Corrosion Metal | Distance [km] | | Dimension | Number of | |
| | loss distribution | | | Class | anomalies/10 km | |
| | by dimension | | | | | |
| | class along the | | | | | |
| | pipeline route | | | | | |
| 8 | Dimension | Length/A | | Width/A | | External |
| | Class Chart | | | | | Internal |
| | | | | | | Mid wall |
| | | | | | | Unknown |
| 9 | Overall | | | | | 10 <= Depth, |
| | Corrosion | | | | | [%] < 20 |
| | Metal loss | | | | | 20 <= Depth, |
| | distribution | | | | | [%] < 40 |
| | by depth | | | | | 40 <= Depth, |
| | | | | | | [%] < 60 |
| | | | | | | Depth >= 60 |
| 10 | Corrosion Metal | Distance [km] | | Anomaly | Number of | |
| | loss distribution | | | Depth, % | anomalies/10 km | |
| | by depth along | | | | | |
| | the pipeline route | | | | | |
| 11 | Metal loss | Distance [km] | | Number of | | External |
| | distribution | | | anomalies/10 km | | Internal |
| | by depth and | | | | | Mid wall |
| | log distance | | | | | Unknown |
| 12 | Metal loss | Orientation, | | Number of | | External |
| | distribution | O'clock | | anomalies | | Internal |
| | by Anomaly | | | | | Mid wall |
| | Orientation | | | | | Unknown |
| 13 | Corrosion metal | Distance [km] | | Orientation, | | Internal |
| | loss distribution | | | O'clock | | Mid wall |
| | by orientation | | | | | |
| | and log distance | | | | | |
| 14 | Corrosion metal | Distance [km] | | Orientation, | | External |
| | loss distribution | | | O'clock | | |
| | by orientation | | | | | |
| | and log distance | | | | | |
| 15 | Corrosion metal | Distance [km] | | Length, [mm] | | External |
| | loss distribution | | | | | Internal |
| | (Without | | | | | Mid wall |
| | Tolerances) | | | | | Unknown |
| | by length of | | | | | |
| | corrosion and | | | | | |
| | log distance | | | | | |
| 16 | Corrosion metal | Distance [km] | | Depth, % of | | External |
| | loss distribution | | | wall thickness | | Internal |
| | by depth of | | | | | Mid wall |
| | corrosion | | | | | Unknown |
| | (Without | | | | | |
| | Tolerances) and | | | | | |
| | log distance | | | | | |
| 17 | Corrosion metal | Distance [km] | | Depth, % of | | External |
| | loss distribution | | | wall thickness | | Internal |
| | by depth of | | | | | Mid wall |
| | corrosion | | | | | Unknown |
| | (With Tolerances) | | | | | |
| | and log distance | | | | | |
| 18 | Corrosion metal | Distance from | | Orientation, | | Internal |
| | loss distribution | nearest girth | | O'clock | | Mid wall |
| | by orientation | weld, [m] | | | | Unknown |
| | and distance | | | | | |
| | from nearest | | | | | |
| | girth weld | | | | | |
| 19 | Corrosion metal | Distance from | | Orientation, | | External |
| | loss distribution | nearest girth | | O'clock | | |
| | by orientation | weld, [m] | | | | |
| | and distance | | | | | |
| | from nearest | | | | | |
| | girth weld | | | | | |
| 20 | Corrosion metal | Distance, [km] | | Distance | | Internal |
| | loss distribution | | | from nearest | | Mid wall |
| | by log distance | | | girth weld, [m] | | Unknown |
| | from nearest | | | | | |
| | longitudinal seam | | | | | |
| 21 | Corrosion metal | Distance, [km] | | Distance | | External |
| | loss distribution | | | from nearest | | |
| | by log distance | | | girth weld, [m] | | |
| | from nearest | | | | | |
| | longitudinal seam | | | | | |
| 22 | Dimension | ILI Date | | ILI 1 | | GENE (General) |
| | Class for total | | | ILI 2 | | PINH (Pin-hole) |
| | number of | | | . . . | | PITT (Pitting) |
| | metal losses | | | . . . | | AXGR |
| | | | | . . . | | (Axial Grooving) |
| | | | | ILI n | | AXSL |
| | | | | | | (Axial Slotting) |
| | | | | | | CIGR |
| | | | | | | (Circum. Grooving) |
| | | | | | | CISL |
| | | | | | | (Circum. Slotting) |
| 23 | User chart | To be defined | To be defined | To be defined | To be defined | To be defined |
| | | by user | by user | by user | by user | by user |

ILI Conversion Data Model

A standard data model for conversion according to a non-limiting embodiment is described below.

Description of Tables/Features

According to a non-limiting embodiment, each feature or table of a data model has certain required information such as the below items:

Name

According to a non-limiting embodiment, all required data in a data model has a special name. In relevant rows, each name has special required information including data type, primary condition, foreign key, and mandatory condition.

Data Types

According to a non-limiting embodiment, the Abstract Data Types package contains a number of “abstract” data types, which each contain one or more properties that relate to their named function. The abstract data types are included by reference in several of the data model classes. When physical models are generated these references are replaced by their properties. These data types are intended to make easier to extend by individual companies/implementers. Different types of data are described in Table 4 below.

TABLE 4

| Data type | Explanation |
|---|---|
| Char(size) | Fixed-length character string. Size is specified in brackets. |
| Varchar(size) | Variable-length character string. Maximum size is specified in brackets. |
| Number(size) | Number value with a maximum number of column digits specified in brackets. |
| Date | Date value |
| Float(size, d) | Number value with a maximum number of digits of ‘size’ total, with a |
| | maximum number of ‘d’ digits to the right of the decimal. |
| Char(1) | True/False values. |

Primary Key

In database design, a primary key is important because it serves as a unique identifier for a row of data in a database table. A primary key makes it convenient for a user to add, sort, modify or delete data in a database. One of the critical steps in database programming is the inclusion of a primary key to a database table. This ensures that each record in the table is distinct from other records, which eliminates the possibility of duplicate data. A primary key is composed of one or several column fields. Once a primary key is added to a table, it should remain constant and should not deviate from its purpose, which is to identify a database record.

Foreign Key

Foreign keys are structured into a database as a common component linking together two tables. A foreign key must always reference a primary key elsewhere.

The original table is called the parent table or referenced table, and the referencing table with a foreign key is called a child table. Foreign key references are stored within a child table and links up to a primary key in a separate table. The column acting as a foreign key must have a corresponding value in its linked table. This creates referential integrity.

Mandatory

Mandatory: Controls whether referential integrity is enforced. If this option is enabled, referential integrity is enforced (that is, a matching value in the table for the referenced primary key is mandatory); and if a matching value does not exist, a record cannot be created in the current table.

The relationship between an 1) instance of the order entity and 2) an instance of the customer entity is a mandatory relationship. Identifying weak entities and their associated mandatory relationships can be very important for maintaining the consistency and integrity of the database.

Comment Column

In the second tables of each feature, the column named “comment” describes each name in the previous table and provides high-level relevant information.

In Line Inspection

Table ILI Cluster

As shown below in Table 5 and Table 6, according to a non-limiting embodiment, an ILI Cluster represents a grouping of individual anomalies as identified by a particular cluster rule. Each cluster represents a location on the pipeline with a specified length and width—the ‘call box’. All anomalies contained within the ‘call box’ are summarized in the cluster record.

TABLE 5

| | | | Foreign | |
|---|---|---|---|---|
| Name | Data Type | Primary | Key | Mandatory |
| ILI_Cluster_ID | NUMBER(16) | TRUE | FALSE | TRUE |
| Event_ID | NUMBER(16) | FALSE | TRUE | FALSE |
| Description | VARCHAR2(50) | FALSE | FALSE | FALSE |
| Create_Date | DATE | FALSE | FALSE | FALSE |
| Avg_BPR_Calculated | NUMBER(16, 6) | FALSE | FALSE | FALSE |
| Avg_BPR_Pig | NUMBER(16, 6) | FALSE | FALSE | FALSE |
| Avg_BPR_Variance | NUMBER(16, 6) | FALSE | FALSE | FALSE |
| Avg_Depth | NUMBER(7, 3) | FALSE | FALSE | FALSE |
| Avg_Length | NUMBER(7, 3) | FALSE | FALSE | FALSE |
| Avg_Max_Diameter | NUMBER(8, 4) | FALSE | FALSE | FALSE |
| Avg_Min_Diameter | NUMBER(8, 4) | FALSE | FALSE | FALSE |
| Avg_Orientation | NUMBER(4) | FALSE | FALSE | FALSE |
| Avg_RPR_Calculated | NUMBER(16, 6) | FALSE | FALSE | FALSE |
| Avg_RPR_Pig | NUMBER(16, 6) | FALSE | FALSE | FALSE |
| Avg_RPR_Variance | NUMBER(16, 6) | FALSE | FALSE | FALSE |
| Avg_Width | NUMBER(7, 3) | FALSE | FALSE | FALSE |
| R85_Burst_Pressure | NUMBER(16, 6) | FALSE | FALSE | FALSE |
| Effective_Length | NUMBER(7, 3) | FALSE | FALSE | FALSE |
| Effective_Width | NUMBER(7, 3) | FALSE | FALSE | FALSE |
| Effective_Area | FLOAT | FALSE | FALSE | FALSE |
| Safety_Factor | FLOAT | FALSE | FALSE | FALSE |
| Anomaly_Count | NUMBER(5) | FALSE | FALSE | FALSE |
| Max_Wall_Loss | NUMBER(6, 4) | FALSE | FALSE | FALSE |
| ILI_Inspection_ID | NUMBER(16) | FALSE | TRUE | FALSE |
| Source_CL | VARCHAR2(16) | FALSE | TRUE | FALSE |
| Comments | VARCHAR2(255) | FALSE | FALSE | FALSE |

TABLE 6

| Name | Comment |
|---|---|
| ILI_Cluster_ID | Unique ID for the ILI_Cluster recordToken |
| Event_ID | Unique identifier for each event referencing the EVENT_RANGEtable. |
| Description | Free format description of the feature. |
| Create_Date | Date that the Cluster record was originally created. |
| Avg_BPR_Calculated | Average Burst Pressure Ratio (BPR) calculated for each anomaly inthe cluster |
| Avg_BPR_Pig | Average Burst Pressure Ratio (BPR) as determined by the inspectiontool for |
| | each anomaly in the cluster |
| Avg_BPR_Variance | Average variance between BPR_Calculated and BPR_PIG for eachanomaly in |
| | the cluster |
| Avg_Depth | Average wall loss depth of all anomalies in the cluster |
| Avg_Length | Average anomaly length of each anomaly in the cluster |
| Avg_Max_Diameter | Average maximum pipe internal diameter within the cluster |
| Avg_Min_Diameter | Average minimum pipe internal diameter within the cluster |
| Avg_Orientation | Average clock orientation of anomalies within the cluster |
| Avg_RPR_Calculated | Average Rupture Pressure Ratio (BPR) calculated for each anomalyin the |
| | cluster |
| Avg_RPR_Pig | Average Rupture Pressure Ratio (BPR) as determined by theinspection tool |
| | for each anomaly in the cluster |
| Avg_RPR_Variance | Average variance between RPR_Calculated and BPR_PIG for eachanomaly in |
| | the cluster |
| Avg_Width | Average width of each anomaly within the cluster |
| R85_Burst_Pressure | Burst pressure using the R85 methodology having to do with the bendradius |
| Effective_Length | Effective Length of the cluster |
| Effective_Width | Effective Width of the cluster |
| Effective_Area Safety_Factor | Effect Surface Area of the clusterPressure safety factor |
| Anomaly_Count | Number of anomalies within cluster |
| Max_Wall_Loss | Maximum wall loss of anomalies within cluster |
| ILI_Inspection_ID | FK of ILI_Inspection record (the inspection for this ILI run) |
| Source_CL | Code list to record the source of the feature. |
| Comments | Free format details of the feature |

Table ILI Data

According to a non-limiting embodiment, as shown below in Table 7 and Table 8, the ILI Data table is used to record the data associated with an ILI inspection. Table columns include data taken during the inspection, data updated post inspection, and data calculated post inspection. Data taken during the inspection may be reclassified after additional review or simply updated with more specific information.

TABLE 7

| Name | Data Type | Primary | ForeignKey | Mandatory |
|---|---|---|---|---|
| ILI_Data_ID | NUMBER(16) | TRUE | FALSE | TRUE |
| Event_ID | NUMBER(16) | FALSE | TRUE | FALSE |
| US_Weld_Number | VARCHAR2(16) | FALSE | FALSE | FALSE |
| DS_Weld_Number | VARCHAR2(16) | FALSE | FALSE | FALSE |
| Date_Collected | DATE | FALSE | FALSE | FALSE |
| Absolute_Odometer | NUMBER(16, 3) | FALSE | FALSE | FALSE |
| US_Weld_Odometer | NUMBER(16, 3) | FALSE | FALSE | FALSE |
| US_Weld_Distance | NUMBER(16, 3) | FALSE | FALSE | FALSE |
| DS_Weld_Odometer | NUMBER(16, 3) | FALSE | FALSE | FALSE |
| DS_Weld_Distance | NUMBER(16, 3) | FALSE | FALSE | FALSE |
| US_AGM_Distance | NUMBER(16, 3) | FALSE | FALSE | FALSE |
| DS_AGM_Distance | NUMBER(16, 3) | FALSE | FALSE | FALSE |
| US_AGM_Reference | VARCHAR2(50) | FALSE | FALSE | FALSE |
| DS_AGM_Reference | VARCHAR2(50) | FALSE | FALSE | FALSE |
| Raw_Reference_Key | VARCHAR2(32) | FALSE | FALSE | FALSE |
| Max_Depth_Pct | NUMBER(5, 3) | FALSE | FALSE | FALSE |
| Max_Depth_Measured | NUMBER(7, 3) | FALSE | FALSE | FALSE |
| Average_Depth | NUMBER(7, 3) | FALSE | FALSE | FALSE |
| Length | NUMBER(6, 3) | FALSE | FALSE | FALSE |
| Width | NUMBER(7, 3) | FALSE | FALSE | FALSE |
| Orientation | NUMBER(4) | FALSE | FALSE | FALSE |
| Anomaly_Type_CL | NUMBER(5) | FALSE | TRUE | FALSE |
| Internal_External_CL | VARCHAR2(16) | FALSE | TRUE | FALSE |
| Anomaly_Extension_CL | VARCHAR2(16) | FALSE | TRUE | FALSE |
| Ovality | NUMBER(6, 4) | FALSE | FALSE | FALSE |
| Axial_Ovality | NUMBER(6, 4) | FALSE | FALSE | FALSE |
| Seam_Orientation | NUMBER(4) | FALSE | FALSE | FALSE |
| Measured_Wall_Thickness | NUMBER(6, 4) | FALSE | FALSE | FALSE |
| B31G_MAOP | NUMBER(5) | FALSE | FALSE | FALSE |
| B31G_ERF | NUMBER(8, 6) | FALSE | FALSE | FALSE |
| MODB31G_MAOP | NUMBER(5) | FALSE | FALSE | FALSE |
| MODB31G_ERF | NUMBER(8, 6) | FALSE | FALSE | FALSE |
| BPR_Calculated | NUMBER(16, 6) | FALSE | FALSE | FALSE |
| BPR_Pig | NUMBER(16, 6) | FALSE | FALSE | FALSE |
| Burst_Pressure | NUMBER(5) | FALSE | FALSE | FALSE |
| BPR_Variance | NUMBER(16, 6) | FALSE | FALSE | FALSE |
| RPR_Calculated | NUMBER(16, 6) | FALSE | FALSE | FALSE |
| RPR_Pig | NUMBER(16, 6) | FALSE | FALSE | FALSE |
| RPR_Variance | NUMBER(16, 6) | FALSE | FALSE | FALSE |
| Milepost | VARCHAR2(16) | FALSE | FALSE | FALSE |
| Coordinate_ID | NUMBER(16) | FALSE | TRUE | FALSE |
| Certainty_Interval | FLOAT | FALSE | FALSE | FALSE |
| Depth_Accuracy | FLOAT | FALSE | FALSE | FALSE |
| Length_Accuracy | FLOAT | FALSE | FALSE | FALSE |
| Width_Accuracy | FLOAT | FALSE | FALSE | FALSE |
| Within_Specification_LF | CHAR(1) | FALSE | FALSE | FALSE |
| Feature_Description | VARCHAR2(50) | FALSE | FALSE | FALSE |
| Control_Point_LF | CHAR(1) | FALSE | FALSE | FALSE |
| ILI_Cluster_ID | NUMBER(16) | FALSE | TRUE | FALSE |
| Ref_Event_ID | NUMBER(16) | FALSE | TRUE | FALSE |
| ILI_Inspection_ID | NUMBER(16) | FALSE | TRUE | FALSE |
| Station_Reported | FLOAT | FALSE | FALSE | FALSE |
| Calibrated_Measure | NUMBER(12, 2) | FALSE | FALSE | FALSE |
| Description | VARCHAR2(50) | FALSE | FALSE | FALSE |
| Source_CL | VARCHAR2(16) | FALSE | TRUE | FALSE |
| Comments | VARCHAR2(255) | FALSE | FALSE | FALSE |

TABLE 8

| Name | Comment |
|---|---|
| ILI_Data_ID | Unique ID for the ILI_Data record |
| Event_ID | Unique identifier for each event referencing the EVENT_RANGEtable. |
| US_Weld_Number | If each weld along the pipeline is assigned a unique ascendingnumeric value, |
| | the upstream weld number for each non-weld anomaly is stored in this |
| | column. This column is Null for anomalies that are classified as welds. |
| DS_Weld_Number | If each weld along the pipeline is assigned a unique ascendingnumeric value |
| | (i.e. 10, 20, 30, . . .), the weld number is stored in this column. Values are only |
| | stored in weld (pipe join) records. The column should be Null for all |
| | anomalies that arenot classified as welds. |
| Date_Collected | Date the ILI data was collected. |
| Absolute_Odometer | Actual ILI tool odometer |
| US_Weld_Odometer | Odometer of nearest upstream weld |
| US_Weld_Distance | Distance from current anomaly to nearest upstream weld |
| DS_Weld_Odometer | Odometer of nearest downstream weld |
| DS_Weld_Distance | Distance from current anomaly to nearest upstream |
| US_AGM_Distance | AGM Distance from current anomaly to nearest downstream |
| DS_AGM_Distance | AGM Distance from current anomaly to nearest upstream weld |
| US_AGM_Reference | AGM Reference identifier of nearest upstream AGM (AGM Identifier) |
| DS_AGM_Reference | Reference identifier of nearest downstream AGM (AGM Identifier) |
| Raw_Reference_Key | RAW data reference key reserved for ILI vendor data |
| Max_Depth_Pct | Maximum depth of wall loss as percentage of actual wall thickness |
| Max_Depth_Measured | Actual measured depth of wall loss |
| Average_Depth | Average depth of wall loss for the anomaly |
| Length | Length of anomaly |
| Width | Width of anomaly |
| Orientation | Decimal degree orientation of anomaly (Noon position is 0 degrees), |
| | measured clockwise |
| Anomaly_Type_CL | FK to Anomaly_Type_CL table. This record identifies theclassification type of |
| | the anomaly as determined by the ILI vendor and/or pipeline operator. The |
| | classification may be updated when the operator performs a physical pipe |
| | inspection and determines the precise type and classification of the |
| | anomaly, which would then be recorded in Anomaly_Extension_CL. |
| Internal_External_CL | Code list to record internal or external position of an anomaly |
| Anomaly_Extension_CL | Code list to record the classification of the anomaly after a physicalpipe |
| | inspection. |
| Ovality | Degree of pipe transverse ovality, measured as deviation from round |
| Axial_Ovality | Degree of pipe axial ovality, measured as deviation from normal Decimal |
| Seam_Orientation | degree position of pipe seam (Noon position is 0 degrees), measured |
| | clockwise |
| Measured_Wall_Thickness | Measured actual wall thickness of pipe at anomaly |
| B31G_MAOP | Pipe MAOP as calculated using ASME B31G |
| B31G_ERF | Pipe Estimated Repair Factor (ERF) using ASME B31G. Commonly, a Estimated |
| | Repair Factor (ERF) is calculated which is the MOP of the pipeline dividedby |
| | the Estimated MOP for individual corrosion pits detected by the smart pig. A |
| | valuegreater than one indicates that repairs may be required. Values less |
| | than one may notneed to be repaired. |
| MODB31G_MAOP | Pipe MAOP as calculated using Modified B31G |
| MODB31G_ERF | Pipe Estimated Repair Factor (ERF) using Modified B31G |
| BPR_Calculated | Burst Pressure Ratio calculated |
| BPR_Pig | Burst Pressure Ratio as determined by ILI Tool |
| Burst_Pressure | Field for storage of Burst Pressure using other special or proprietaryformula |
| | Numeric variance between calculated BPR and smart pig BPR Rupture |
| BPR_Variance | Pressure Ratio calculated |
| RPR_Calculated | Rupture Pressure Ratio as calculated from ILI Tool Numeric variance |
| RPR_Pig | between RPR_Calculated and RPR_Pig |
| RPR_Variance | Approximate pipeline milepost |
| Milepost Coordinate_ID | FK to Coordinate record - Geographic coordinate of anomaly (notrequired) |
| Certainty_Interval | Computed or interpreted interval for re-inspection |
| Depth_Accuracy | Accuracy tolerance of tool measurements for anomaly depth |
| Length_Accuracy | Accuracy tolerance of tool measurements for anomaly length |
| Width_Accuracy | Accuracy tolerance of tool measurements for anomaly width |
| Within_Specification_LF | Logical flag to indicate whether the anomaly measurements are within |
| | specification of the tools capabilities |
| Feature_Description | General description of anomaly |
| Control_Point_LF | Logical flag to indicate whether an anomaly was used as a linearreference or |
| ILI_Cluster_ID | geographic alignment control point |
| Ref_Event_ID | FK to ILI Cluster that this anomaly belongs to |
| | FK to Event_Range table corresponding to the data model Event for the ILI |
| | feature. Examples may include Valve, Tap, Casing, permanent AGM, |
| ILI_Inspection_ID | Pipe_Segment for wall thickness change, etc. |
| | Unique identifier of the ILI Run where the anomaly was collected |
| Station_Reported | Computed engineering station of anomaly during alignment |
| Calibrated_Measure | Computed equivalent Measure for anomaly, corresponding with Measure |
| | along Route. |
| Description | Free format description of the feature. |
| Source_CL | Code list to record the source of the feature. |
| Comments | Free format details of the feature |

Table ILI Inspection

As shown below in Table 9 and Table 10, according to a non-limiting embodiment, each record represents one completed in-line inspection run and pertinent data related to the tool run. Because of the temporary or permanent configuration of the pipeline itself versus the storage of the Line/Route hierarchy, there may be one or more ILI_Inspection_Range records related to the single ILI inspection run.

One ILI Inspection record is related to one or more ILI_Inspection_Range records. Ideally, each ILI_Inspectiontool run is contained exactly within one Route. Because of temporary pipe reconfiguration or because of the method used to organize Line and child Routes within the data model, the ILI tool run may span one or more routes.

Without this relationship, the Routes would need to be modified to match the ILI run length, or the one ILI run would need to be broken into multiple ILI Inspection records, one for each route.

TABLE 9

| | | | Foreign | |
|---|---|---|---|---|
| Name | Data Type | Primary | Key | Mandatory |
| ILI_Inspection_ID | NUMBER(16) | TRUE | FALSE | TRUE |
| Begin_Date | DATE | FALSE | FALSE | FALSE |
| End_Date | DATE | FALSE | FALSE | FALSE |
| Tool_Type_CL | VARCHAR2(16) | FALSE | TRUE | FALSE |
| Tool_Vendor_CL | VARCHAR2(16) | FALSE | TRUE | FALSE |
| Sampling_Fre- | VARCHAR2(16) | FALSE | FALSE | FALSE |
| quency | | | | |
| Resolution | VARCHAR2(16) | FALSE | FALSE | FALSE |
| Model | VARCHAR2(32) | FALSE | FALSE | FALSE |
| Sensor_CL | VARCHAR2(16) | FALSE | TRUE | FALSE |
| Sensor_Spac- | NUMBER(6, 4) | FALSE | FALSE | FALSE |
| ing_Min | | | | |
| Sensor_Spac- | NUMBER(6, 4) | FALSE | FALSE | FALSE |
| ing_Max | | | | |
| Max_Temp | NUMBER(4) | FALSE | FALSE | FALSE |
| Min_Temp | NUMBER(4) | FALSE | FALSE | FALSE |
| Avg_Temp | NUMBER(4) | FALSE | FALSE | FALSE |
| Max_Velocity | NUMBER(7, 3) | FALSE | FALSE | FALSE |
| Min_Velocity | NUMBER(7, 3) | FALSE | FALSE | FALSE |
| Avg_Velocity | NUMBER(7, 3) | FALSE | FALSE | FALSE |
| Rated_Max_Ve- | NUMBER(7, 3) | FALSE | FALSE | FALSE |
| locity | | | | |
| Rated_Max_WT | NUMBER(8, 3) | FALSE | FALSE | FALSE |
| Start_Odometer | NUMBER(16, 3) | FALSE | FALSE | FALSE |
| End_Odometer | NUMBER(16, 3) | FALSE | FALSE | FALSE |
| Cluster_Rule_CL | VARCHAR2(16) | FALSE | TRUE | FALSE |
| Source_CL | VARCHAR2(16) | FALSE | TRUE | FALSE |
| Comments | VARCHAR2(255) | FALSE | FALSE | FALSE |

TABLE 10

| Name | Comment |
|---|---|
| ILI_Inspection_ID | Unique ID for ILI inspection record |
| Begin_Date | Begin time/date of ILI inspection |
| End_Date | Ending time/date of ILI inspection |
| Tool_Type_CL | Type of ILI Tool used, or combination of tools |
| Tool_Vendor_CL | ILI Vendor name |
| Sampling_Fre- | Sampling frequency of ILI tool - tool specification |
| quency | |
| Resolution | Tool measurement resolution - tool specification |
| Model | Tool model number |
| Sensor_CL | Code list to record the type of sensor used in the inspection. |
| Sensor_Spacing_Min | Minimum distance of sensor spacing |
| Sensor_Spacing_Max | Maximum distance of sensor spacing |
| Max_Temp | Maximum temperature measured during ILI run |
| Min_Temp | Minimum temperature measured during ILI run |
| Avg_Temp | Average temperature measured during ILI run |
| Max_Velocity | Maximum velocity measured during ILI run |
| Min_Velocity | Minimum velocity measured during ILI run |
| Avg_Velocity | Average velocity measured during ILI run |
| Rated_Max_Velocity | Rated maximum velocity for ILI tool |
| Rated_Max_WT | Rated maximum wall thickness for ILI tool |
| Start_Odometer | Starting odometer for ILI run |
| End_Odometer | Ending odometer for ILI run |
| Cluster_Rule_CL | Code list to record the interaction rules for grouping anomalies in close |
| | proximity into clusters. |
| Source_CL | Code list to record the source of the feature. |
| Comments | Free format details of the feature |

Table ILI Inspection Range

As shown below in Table 11 and Table 12, according to a non-limiting embodiment, each record represents one or more segments of the entire ILI tool inspection run. The ILI Run may span one or more routes but the Range does not.

TABLE 11

| | | | Foreign | |
|---|---|---|---|---|
| Name | Data Type | Primary | Key | Mandatory |
| ILI_Inspection_ID | NUMBER(16) | TRUE | FALSE | TRUE |
| Begin_Date | DATE | FALSE | FALSE | FALSE |
| End_Date | DATE | FALSE | FALSE | FALSE |
| Tool_Type_CL | VARCHAR2(16) | FALSE | TRUE | FALSE |
| Tool_Vendor_CL | VARCHAR2(16) | FALSE | TRUE | FALSE |
| Sampling_Fre- | VARCHAR2(16) | FALSE | FALSE | FALSE |
| quency | | | | |
| Resolution | VARCHAR2(16) | FALSE | FALSE | FALSE |
| Model | VARCHAR2(32) | FALSE | FALSE | FALSE |
| Sensor_CL | VARCHAR2(16) | FALSE | TRUE | FALSE |
| Sensor_Spac- | NUMBER(6, 4) | FALSE | FALSE | FALSE |
| ing_Min | | | | |
| Sensor_Spac- | NUMBER(6, 4) | FALSE | FALSE | FALSE |
| ing_Max | | | | |
| Max_Temp | NUMBER(4) | FALSE | FALSE | FALSE |
| Min_Temp | NUMBER(4) | FALSE | FALSE | FALSE |
| Avg_Temp | NUMBER(4) | FALSE | FALSE | FALSE |
| Max_Velocity | NUMBER(7, 3) | FALSE | FALSE | FALSE |
| Min_Velocity | NUMBER(7, 3) | FALSE | FALSE | FALSE |
| Avg_Velocity | NUMBER(7, 3) | FALSE | FALSE | FALSE |
| Rated_Max_Ve- | NUMBER(7, 3) | FALSE | FALSE | FALSE |
| locity | | | | |
| Rated_Max_WT | NUMBER(8, 3) | FALSE | FALSE | FALSE |
| Start_Odometer | NUMBER(16, 3) | FALSE | FALSE | FALSE |
| End_Odometer | NUMBER(16, 3) | FALSE | FALSE | FALSE |
| Cluster_Rule_CL | VARCHAR2(16) | FALSE | TRUE | FALSE |
| Source_CL | VARCHAR2(16) | FALSE | TRUE | FALSE |
| Comments | VARCHAR2(255) | FALSE | FALSE | FALSE |

TABLE 12

| Name | Comment |
|---|---|
| ILI_Inspection_ID | Unique ID for ILI inspection record |
| Begin_Date | Begin time/date of ILI inspection |
| End_Date | Ending time/date of ILI inspection |
| Tool_Type_CL | Type of ILI Tool used, or combination of tools |
| Tool_Vendor_CL | ILI Vendor name |
| Sampling_Frequency | Sampling frequency of ILI tool - tool specification |
| Resolution | Tool measurement resolution - tool specification |
| Model | Tool model number |
| Sensor_CL | Code list to record the type of sensor used in the inspection. |
| Sensor_Spacing_Min | Minimum distance of sensor spacing |
| Sensor_Spacing_Max | Maximum distance of sensor spacing |
| Max_Temp | Maximum temperature measured during ILI run |
| Min_Temp | Minimum temperature measured during ILI run |
| Avg_Temp | Average temperature measured during ILI run |
| Max_Velocity | Maximum velocity measured during ILI run |
| Min_Velocity | Minimum velocity measured during ILI run |
| Avg_Velocity | Average velocity measured during ILI run |
| Rated_Max_Velocity | Rated maximum velocity for ILI tool |
| Rated_Max_WT | Rated maximum wall thickness for ILI tool |
| Start_Odometer | Starting odometer for ILI run |
| End_Odometer | Ending odometer for ILI run |
| Cluster_Rule_CL | Code list to record the interaction rules for grouping anomalies in close |
| | proximity into clusters. |
| Source_CL | Code list to record the source of the feature. |
| Comments | Free format details of the feature |

Table ILI Pipe Length

As shown in Table 13 and Table 14, according to a non-limiting embodiment, a table contains information regarding the inline inspection of a pipe joint—weld to weld. This is linear event data that describes ILI inspection on a joint per joint basis.

TABLE 13

| | | | Foreign | |
|---|---|---|---|---|
| Name | Data Type | Primary | Key | Mandatory |
| ILI_Pipe_Length_ID | NUMBER(16) | TRUE | FALSE | TRUE |
| Event_ID | NUMBER(16) | FALSE | TRUE | FALSE |
| Description | VARCHAR2(50) | FALSE | FALSE | FALSE |
| Weld_Number | VARCHAR2(16) | FALSE | FALSE | FALSE |
| Sequence_Number | NUMBER(4) | FALSE | FALSE | FALSE |
| Start_Odometer | NUMBER(16, 3) | FALSE | FALSE | FALSE |
| End_Odometer | NUMBER(16, 3) | FALSE | FALSE | FALSE |
| Start_Coordinate_ID | NUMBER(16) | FALSE | TRUE | FALSE |
| End_Coordinate_ID | NUMBER(16) | FALSE | TRUE | FALSE |
| Seam_Orientation | NUMBER(4) | FALSE | FALSE | FALSE |
| Measured_Wall_Thickness | NUMBER(6, 4) | FALSE | FALSE | FALSE |
| Nominal_Wall_Thickness | NUMBER(6, 4) | FALSE | FALSE | FALSE |
| ILI_Inspection_ID | NUMBER(16) | FALSE | TRUE | FALSE |
| Ref_Event_ID | NUMBER(16) | FALSE | TRUE | FALSE |
| Source_CL | VARCHAR2(16) | FALSE | TRUE | FALSE |
| Comments | VARCHAR2(255) | FALSE | FALSE | FALSE |

TABLE 14

| Name | Comment |
|---|---|
| ILI_Pipe_Length_ID | Unique ID of each ILI_Pipe_Length record |
| Event_ID | Unique identifier for each event referencing the EVENT_RANGEtable. |
| Description | Free format description of the feature. |
| Weld_Number | Number (label) of upstream weld |
| Sequence_Number | Continuous ascending computed numeric sequence of weld withrespect to |
| | all welds on the tool run |
| Start_Odometer | Beginning odometer of upstream weld of pipe joint |
| End_Odometer | Ending odometer for downstream weld of pipe joint |
| Start_Coordinate_ID | If populated, this is a FK to the Coordinate table and represents the |
| | geographic location of the weld |
| End_Coordinate_ID | If populated, this is a FK to the Coordinate table and represents the |
| | geographic location of the weld |
| Seam_Orientation | The seam orientation for the entire pipe joint - typically 10 o'clock or 2 |
| | o'clock position expressed as decimal degrees (60 and 300 degrees) |
| Measured_Wall_Thickness | Actual measured wall thickness of the pipe |
| Nominal_Wall_Thickness | Manufactured specified wall thickness of pipe within manufacturers |
| | tolerances |
| ILI_Inspection_ID | FK to ILI_Inspection Record - parent ILI run |
| Ref_Event_ID | FK to Event_Range table for the Pipe_Length event record (if itexists) |
| Source_CL | Code list to record the source of the feature. |
| Comments | Free format details of the feature |

Table ILI Range

According to a non-limiting embodiment, Table 15 and Table 16 show table records if the inspection range can be pigged by a regular or smart pig and the date of the last inspection.

TABLE 15

| | | | Foreign | |
|---|---|---|---|---|
| Name | Data Type | Primary | Key | Mandatory |
| Event_ID | NUMBER(16) | TRUE | TRUE | TRUE |
| Smart_Pigg- | CHAR(1) | FALSE | FALSE | FALSE |
| able_LF | | | | |
| Piggable_LF | CHAR(1) | FALSE | FALSE | FALSE |
| Date_Last_Pigged | DATE | FALSE | FALSE | FALSE |
| Description | VARCHAR2(50) | FALSE | FALSE | FALSE |
| Source_CL | VARCHAR2(16) | FALSE | TRUE | FALSE |
| Comments | VARCHAR2(255) | FALSE | FALSE | FALSE |

TABLE 16

| Name | Comment |
|---|---|
| Event_ID | Unique identifier for each event referencing the EVENT_RANGEtable. |
| Smart_Piggable_LF | Logical flag to indicate if the line is piggable by a smart pipe. |
| | Allowed values are “Y” and “N”. |
| Piggable_LF | Logical flag to indicate if the line is piggable. |
| | Allowed values are “Y”and “N”. |
| Date_Last_Pigged | Date when the line was last inspected by a pig. |
| Description | Free format description of the feature. |
| Source_CL | Code list to record the source of the feature. |
| Comments | Free format details of the feature |

Table Inspection Contact

According to a non-limiting embodiment, as shown in Table 17 and Table 18 Each record represents that name of a primary contact person from the ILI or other Inspection Company, contractor, pipeline operator, or other party involved in the pipeline inspection.

TABLE 17

| | | | Foreign | |
|---|---|---|---|---|
| Name | Data Type | Primary | Key | Mandatory |
| ILI_Inspection_ID | NUMBER(16) | TRUE | TRUE | TRUE |
| Contact_ID | NUMBER(16) | TRUE | TRUE | TRUE |

TABLE 18

| Name | Comment |
|---|---|
| ILI_Inspection_ID | FK to the ILI Inspection with which the contact is associated |
| Contact_ID | FK to the contact information for the contact person |

Table Inspection Interval

A non-limiting embodiment may comprise a Table Inspection Interval, as shown in Table 19 and Table 20.

TABLE 19

| | | | Foreign | |
|---|---|---|---|---|
| Name | Data Type | Primary | Key | Mandatory |
| Event_ID | NUMBER(16) | TRUE | TRUE | TRUE |
| Interval_CL | VARCHAR2(16) | FALSE | TRUE | TRUE |
| Source_CL | VARCHAR2(16) | FALSE | TRUE | FALSE |
| Description | VARCHAR2(50) | FALSE | FALSE | FALSE |
| Comments | VARCHAR2(255) | FALSE | FALSE | FALSE |

TABLE 20

| Name | Comment |
|---|---|
| Event_ID | Unique identifier for each event referencing the EVENT_RANGE table. |
| Interval_CL | Code list value indicating the Inspection Interval |
| Source_CL | Code to record the source of the feature. Free format description of the |
| | feature. |
| Description | Free format details of the feature |
| Comments | |

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Embodiments of the disclosure have been shown and described above, however, the embodiments of the disclosure are not limited to the aforementioned specific embodiments. It may be understood that various modifications, substitutions, and improvements can be made by those having ordinary skill in the art in the technical field to which the disclosure belongs, without departing from the spirit of the disclosure as claimed by the appended claims. It should be understood that such modifications, substitutions, and improvements shall fall within the protection scope of the disclosure, and should not to be construed independently from the technical idea or prospect of the disclosure.

What is claimed is:

1. A method comprising:
collecting, by a processor, In-Line Inspection (ILI) pipeline inspection reports having different formats;
converting, by the processor, the different In-Line Inspection (ILI) pipeline inspection reports into one standard platform; and
providing, by the processor, an integrated pipeline data user interface using the one standard platform.

2. The method of claim 1, the method further comprising converting log distances from the ILI pipeline inspection reports having different formats into the one standard platform.

3. The method of claim 1, the method further comprising converting geo mapping coordinates from the ILI pipeline inspection reports having different formats into World Geodetic System (WGS) WGS1984 format.

4. The method of claim 1, the method further comprising converting each one of pipeline features into features of the one standard platform.

5. The method of claim 1, the method further comprising converting joint numbers into the one standard platform.

6. The method of claim 1, the method further comprising converting a pipe length for each joint into the one standard platform.

7. A non-transitory computer readable storage medium storing instructions which, if executed, cause a processor to perform operations comprising:
collecting, by the processor, In-Line Inspection (ILI) pipeline inspection reports having different formats;
converting, by the processor, the different In-Line Inspection (ILI) pipeline inspection reports into one standard platform; and
providing, by the processor, an integrated pipeline data user interface using the one standard platform.

8. The non-transitory computer readable storage medium of claim 7, the operations further comprising converting log distances from the ILI pipeline inspection reports having different formats into the one standard platform.

9. The non-transitory computer readable storage medium of claim 7, the operations further comprising converting geo mapping coordinates from the ILI pipeline inspection reports having different formats into World Geodetic System (WGS) WGS1984 format.

10. The non-transitory computer readable storage medium of claim 7, the operations further comprising converting each one of pipeline features into features of the one standard platform.

11. The non-transitory computer readable storage medium of claim 7, the operations further comprising converting joint numbers into the one standard platform.

12. The non-transitory computer readable storage medium of claim 7, the operations further comprising converting a pipe length for each joint into the one standard platform.
